(19) United States
(12) Patent Application Publication
(10) Pub. No.: US 2022/0169555 A1
(43) Pub. Date: Jun. 2, 2022

(54) GLASS SHEET

(71) Applicant: Nippon Electric Glass Co., Ltd., Shiga (JP)

(72) Inventor: Ryota SUZUKI, Shiga (JP)

(21) Appl. No.: 17/434,185

(22) PCT Filed: Feb. 26, 2020
(86) PCT No.: PCT/JP2020/007596

§ 371 Date: Aug. 26, 2021

(30) Foreign Application Priority Data
Mar. 8, 2019 (JP) 2019-042163
May 14, 2019 (JP) 2019-091144
Jul. 1, 2019 (JP) 2019-122940
Sep. 6, 2019 (JP) 2019-162870

(51) Int. Cl. C03C 3/093; C03C 15/00; C03C 3/091

(52) U.S. Cl. CPC C03C 3/093; C03C 3/091; C03C 15/00

(57) ABSTRACT

A glass sheet of the present invention includes as a glass composition, in terms of mass %, 50% to 72% of SiO₂, 0% to 22% of Al₂O₃, 15% to 38% of B₂O₃, 0% to 3% of Li₂O+Na₂O+K₂O, and 0% to 12% of MgO+CaO+SrO+BaO, and has a specific dielectric constant at 25° C. and a frequency of 10 GHz of 5 or less.

### TECHNICAL FIELD

The present invention relates to a glass sheet, and more specifically, to a glass sheet suitable for a high-frequency device application.

### BACKGROUND ART

Currently, developments are being made to adapt to the fifth-generation mobile communications system (5G), and technical investigations are underway for allowing the system to achieve higher speed, higher transmission capacity, and lower latency.

For example, in Patent Literature 1, there is a disclosure that through holes for arranging electrical signal paths are formed in a thickness direction of a glass sheet. Specifically, there is a disclosure that the glass sheet is irradiated with a laser to form etch paths, and then a plurality of through holes extending from a major surface of the glass sheet are formed along the etch paths using a hydroxide-based etching material. In addition, the glass sheet described in Patent Literature 1 can also be used for a high-frequency device for 5G communications.

### CITATION LIST

### Patent Literature

[PTL 1] JP 2018-531205 A

### SUMMARY OF INVENTION

### Technical Problem

Incidentally, a radio wave having a frequency of several GHz or more is used in 5G communications. In addition, a material to be used for a high-frequency device for 5G communications is required to have low dielectric characteristics in order to reduce the loss of a transmission signal.

However, in Patent Literature 1, there is no description of glass having low dielectric constant characteristics, and hence the above-mentioned need cannot be satisfied.

The present invention has been made in view of the above-mentioned circumstances, and a technical object of the present invention is to provide a glass sheet having low dielectric constant characteristics.

### Solution to Problem

The inventor of the present invention has repeated various experiments, and as a result, has found that the above-mentioned technical object can be achieved by restricting a glass composition range to a predetermined range. The finding is proposed as the present invention. That is, according to one embodiment of the present invention, there is provided a glass sheet, comprising as a glass composition, in terms of mass %, 50% to 72% of SiO₂, 0% to 22% of Al₂O₃, 15% to 38% of B₂O₃, 0% to 3% of Li₂O+Na₂O+K₂O, and 0% to 12% of MgO+CaO+SrO+BaO, and having a specific dielectric constant at 25° C. and a frequency of 10 GHz of 5 or less. Herein, “Li₂O+Na₂O+K₂O” refers to the total content of Li₂O, Na₂O, and K₂O. “MgO+CaO+SrO+BaO” refers to the total content of MgO, CaO, SrO, and BaO. The “specific dielectric constant at 25° C. and a frequency of 10 GHz” may be measured by, for example, a well-known cavity resonator method.

The glass sheet according to the one embodiment of the present invention comprises 15 mass % or more of B₂O₃ in the glass composition. With this configuration, the specific dielectric constant and a dielectric dissipation factor can be reduced. Further, the content of Li₂O+Na₂O+K₂O in the glass composition of the glass according to the one embodiment of the present invention is restricted to 3 mass % or less, and the content of MgO+CaO+SrO+BaO therein is restricted to 12 mass % or less. With this configuration, a reduction in density can be easily achieved, and hence a high-frequency device can be easily lightweighted.

In addition, according to one embodiment of the present invention, there is provided a glass sheet, comprising as a glass composition, in terms of mass %, 50% to 72% of SiO₂, 0% to 22% of Al₂O₃, 15% to 38% of B₂O₃, 0% to 3% of Li₂O+Na₂O+K₂O, and 0% to 12% of MgO+CaO+SrO+BaO, and having a specific dielectric constant at 25° C. and a frequency of 2.45 GHz of 5 or less. Herein, the “specific dielectric constant at 25° C. and a frequency of 2.45 GHz” may be measured by, for example, the well-known cavity resonator method.

In addition, according to one embodiment of the present invention, there is provided a glass sheet, comprising as a glass composition, in terms of mass %, 50% to 72% of SiO₂, 0% to 22% of Al₂O₃, 15% to 38% of B₂O₃, 0% to 3% of Li₂O+Na₂O+K₂O, and 0% to 12% of MgO+CaO+SrO+BaO.

In addition, the glass sheet according to the embodiments of the present invention has a specific dielectric constant at 25° C. and a frequency of 10 GHz of 5 or less. With this configuration, a transmission loss during the transmission of an electrical signal to a high-frequency device can be reduced.

In addition, in the glass sheet according to the embodiments of the present invention, it is preferred that the glass sheet have a mass ratio (MgO+CaO+SrO+BaO)/(SiO₂+Al₂O₃+B₂O₃) of from 0.001 to 0.4. With this configuration, when through holes are formed in the glass sheet by etching, the dimensional accuracy of the through holes can be enhanced without improperly increasing the manufacturing cost of the glass sheet.

In addition, in the glass sheet according to the embodiments of the present invention, it is preferred that the glass sheet have a plurality of through holes formed in a thickness direction. With this configuration, a wiring structure configured to establish conduction between both surfaces of the glass sheet can be formed, and hence its application to a high-frequency device is facilitated.

In addition, in the glass sheet according to the embodiments of the present invention, it is preferred that the through holes have an average inner diameter of 300 μm or less. With this configuration, the density of the wiring structure configured to establish conduction between both surfaces of the glass sheet can be easily increased.

In addition, in the glass sheet according to the embodiments of the present invention, it is preferred that a difference between a maximum value and a minimum value of inner diameters of the through holes be 50 μm or less. With this configuration, a situation in which the wiring configured to establish conduction between both surfaces of the glass sheet is improperly lengthened can be prevented, and hence the transmission loss can be reduced.

In addition, in the glass sheet according to the embodiments of the present invention, it is preferred that a maximum length of a crack in a surface direction extending from the through holes be 100 μm or less. With this configuration, at the time of the production of a high-frequency device, a situation in which the glass sheet is broken through extension of the crack upon application of a tensile stress around the through holes can be easily prevented. Herein, the “maximum length of a crack in a surface direction extending from the through holes” is a value obtained by measuring a length along the shape of the crack in the observation of the through holes from the front and back surface directions of the glass sheet with an optical microscope, and is not a value obtained by measuring the length of a distance between two points, connecting the start point and the end point of the crack, nor a value obtained by measuring the length of a crack in a thickness direction.

In addition, in the glass sheet according to the embodiments of the present invention, it is preferred that the glass sheet have a dielectric dissipation factor at 25° C. and a frequency of 10 GHz of 0.01 or less. With this configuration, the transmission loss during the transmission of an electrical signal to a high-frequency device can be reduced. Herein, the “dielectric dissipation factor at 25° C. and a frequency of 10 GHz” may be measured by, for example, the well-known cavity resonator method.

In addition, in the glass sheet according to the embodiments of the present invention, it is preferred that the glass sheet have a Young's modulus of 40 GPa or more. With this configuration, the glass sheet is less liable to be deflected, and hence wiring failure can be easily reduced at the time of the production of a high-frequency device. Herein, the “Young's modulus” may be measured by, for example, a well-known resonance method.

In addition, in the glass sheet according to the embodiments of the present invention, it is preferred that the glass sheet have a thermal shrinkage rate of 30 ppm or less in a case in which the glass sheet is increased in temperature at a rate of 5° C./min, kept at 500° C. for 1 hour, and decreased in temperature at a rate of 5° C./min. With this configuration, the glass sheet is less liable to be thermally shrunk in a heat treatment step at the time of the production of a high-frequency device, and hence the wiring failure can be easily reduced at the time of the production of the high-frequency device. The “thermal shrinkage rate in a case in which the glass sheet is increased in temperature at a rate of 5° C./min, kept at 500° C. for 1 hour, and decreased in temperature at a rate of 5° C./min” refers to a value measured by the following method. First, a measurement sample is marked with a linear mark at a predetermined position, and then bent perpendicular to the mark to be divided into two glass pieces. Next, one of the glass pieces is subjected to predetermined heat treatment (the glass piece is increased in temperature from normal temperature at a rate of 5° C./min, kept at 500° C. for 1 hour, and decreased in temperature at a rate of 5° C./min). After that, the glass piece having been subjected to the heat treatment and another glass piece not having been subjected to the heat treatment are arranged next to each other, and are fixed with an adhesive tape. Then, a shift between the marks is measured. The thermal shrinkage rate is calculated by the expression ΔL/L₀ (unit: ppm) when the shift between the marks is represented by ΔL and the length of the sample before the heat treatment is represented by L₀.

In addition, in the glass sheet according to the embodiments of the present invention, it is preferred that the glass sheet have a thermal expansion coefficient in a temperature range of from 30° C. to 380° C. of from 20×10⁻⁷/° C. to 50×10⁻⁷/° C. With this configuration, a low-expansion member, such as silicon, can be easily bonded to the glass sheet, and hence its application to a high-frequency device is facilitated. Herein, the “thermal expansion coefficient in a temperature range of from 30° C. to 380° C.” may be measured with, for example, a dilatometer.

In addition, in the glass sheet according to the embodiments of the present invention, it is preferred that a difference between a thermal expansion coefficient in a temperature range of from 20° C. to 300° C. and a thermal expansion coefficient in a temperature range of from 20° C. to 200° C. (value obtained by subtracting the thermal expansion coefficient in a temperature range of from 20° C. to 200° C. from the thermal expansion coefficient in a temperature range of from 20° C. to 300° C.) be 1.0×10⁻⁷/° C. or less. With this configuration, even when a heat treatment temperature is changed in the manufacturing process of a high-frequency device, a change in thermal expansion coefficient of the glass sheet can be reduced to reduce the warpage of the high-frequency device due to a difference in thermal expansion coefficient from a low-expansion member, such as silicon, bonded to the glass sheet. As a result, the yield of the high-frequency device can be enhanced. Herein, the “thermal expansion coefficient” in each temperature range may be measured with, for example, a dilatometer.

In addition, in the glass sheet according to the embodiments of the present invention, it is preferred that the glass sheet have an external transmittance at a wavelength of 355 nm in terms of a thickness of 1.0 mm of 80% or more. Herein, the “external transmittance at a wavelength of 355 nm in terms of a thickness of 1.0 mm” may be measured with a commercially available spectrophotometer (e.g., V-670 manufactured by JASCO Corporation) using a measurement sample obtained by polishing both surfaces into optically polished surfaces (mirror surfaces).

In addition, in the glass sheet according to the embodiments of the present invention, it is preferred that the glass sheet have an external transmittance at a wavelength of 265 nm in terms of a thickness of 1.0 mm of 15% or more. Herein, the “external transmittance at a wavelength of 265 nm in terms of a thickness of 1.0 mm” may be measured with a commercially available spectrophotometer (e.g., V-670 manufactured by JASCO Corporation) using a measurement sample obtained by polishing both surfaces into optically polished surfaces (mirror surfaces).

In addition, in the glass sheet according to the embodiments of the present invention, it is preferred that the glass sheet have a liquidus viscosity of 10^{4.0} dPa·s or more. With this configuration, the glass is less liable to devitrify at the time of forming, and hence the manufacturing cost of the glass sheet can be easily reduced. Herein, the “liquidus viscosity” refers to a value obtained by measuring the viscosity of glass at its liquidus temperature by a platinum sphere pull up method. The “liquidus temperature” refers to a value obtained by measuring a temperature at which a crystal precipitates after glass powder that passes through a standard 30-mesh sieve (500 μm) and remains on a 50-mesh sieve (300 μm) is placed in a platinum boat and kept in a gradient heating furnace for 24 hours.

In addition, in the glass sheet according to the embodiments of the present invention, it is preferred that the glass sheet be formed by an overflow down-draw method. With this configuration, the surface accuracy of the glass sheet can be enhanced. In addition, the manufacturing cost of the glass sheet can be easily reduced.

### DESCRIPTION OF EMBODIMENTS

A glass sheet of the present invention comprises as a glass composition, in terms of mass %, 50% to 72% of SiO₂, 0% to 22% of Al₂O₃, 15% to 38% of B₂O₃, 0% to 3% of Li₂O+Na₂O+K₂O, and 0% to 12% of MgO+CaO+SrO+BaO. The reasons why the contents of the components are limited as described above are described below. In the following description, the expression “%” represents “mass %” unless otherwise stated.

The content of SiO₂ is from 50% to 72%, preferably from 53% to 71%, from 55% to 70%, from 57% to 69.5%, from 58% to 69%, from 59% to 70%, or from 60% to 69%, particularly preferably from 62% to 67%. When the content of SiO₂ is excessively small, a density is liable to be increased. Meanwhile, when the content of SiO₂ is excessively large, a viscosity at high temperature is increased to reduce meltability, and besides, a devitrified crystal, such as cristobalite, is liable to precipitate at the time of forming.

Al₂O₃ is a component that increases a Young's modulus, and is also a component for maintaining weather resistance by suppressing phase separation. Accordingly, the lower limit range of Al₂O₃ is 0% or more, preferably 0.1% or more, 0.2% or more, 0.3% or more, 0.4% or more, 0.5% or more, 1% or more, 2% or more, 3% or more, 4% or more, or 5% or more, particularly preferably 6% or more. Meanwhile, when the content of Al₂O₃ is excessively large, the liquidus temperature becomes high, and hence the devitrification resistance is liable to be reduced. Accordingly, the upper limit range of Al₂O₃ is 22% or less, preferably 20% or less, 19% or less, 18% or less, 17% or less, 15% or less, 13% or less, 12% or less, 11% or less, 10.9% or less, 10.8% or less, 10.7% or less, 10.6% or less, 10.5% or less, 10% or less, 9.9% or less, 9.8% or less, 9.7% or less, 9.6% or less, 9.5% or less, 9.4% or less, 9.3% or less, 9.2% or less, 9.1% or less, 9.0% or less, 8.9% or less, 8.7% or less, 8.5% or less, 8.3% or less, 8.1% or less, 8% or less, 7.9% or less, 7.8% or less, 7.7% or less, 7.6% or less, 7.5% or less, 7.3% or less, or 7.1% or less, particularly preferably 7.0% or less.

B₂O₃ is a component that reduces a dielectric loss and a dielectric dissipation factor, but is a component that reduces the Young's modulus and the density. However, when the content of B₂O₃ is excessively small, low dielectric characteristics are difficult to secure, and besides, its function as a melting accelerate component becomes insufficient, and hence the viscosity at high temperature is increased, with the result that bubble quality is liable to be reduced. Further, a reduction in density is difficult to achieve. Accordingly, the lower limit range of B₂O₃ is 15% or more, preferably 18% or more, 18.1% or more, 18.2% or more, 18.3% or more, 18.4% or more, 18.5% or more, 19% or more, 19.4% or more, 19.5% or more, 19.6% or more, 20% or more, 20% more than, 22% or more, 24% or more, 25% or more, 25.1% or more, 25.3% or more, or 25.5% or more, particularly preferably 25.6% or more. Meanwhile, when the content of B₂O₃ is excessively large, heat resistance and chemical durability are liable to be reduced, and the weather resistance is liable to be reduced through phase separation. Accordingly, the upper limit range of B₂O₃ is 38% or less, preferably 35% or less, 33% or less, 32% or less, 31% or less, 30% or less, 28% or less, or 27% or less.

The content of B₂O₃—Al₂O₃ is preferably −5% or more, −4% or more, −3% or more, −2% or more, −1% or more, 0% or more, 1% or more, 2% or more, 3% or more, 4% or more, 5% or more, 6% or more, 7% or more, 8% or more, or 9% or more, particularly preferably 10% or more. When the content of B₂O₃—Al₂O₃ is excessively small, the low dielectric characteristics are difficult to secure. “B₂O₃—Al₂O₃” is a value obtained by subtracting the content of Al₂O₃ from the content of B₂O₃.

Alkali metal oxides are components that enhance the meltability and formability, but when the contents thereof are excessively large, the density is increased, water resistance is reduced, and a thermal expansion coefficient is improperly increased, with the result that thermal shock resistance is reduced, and that it is difficult for the thermal expansion coefficient to match those of peripheral materials. Accordingly, the content of Li₂O+Na₂O+K₂O is from 0% to 3%, preferably from 0% to 2%, from 0% to 1%, from 0% to 0.5%, from 0% to 0.2%, or from 0% to 0.1%, particularly preferably from 0.001% to less than 0.05%. The content of each of Li₂O, Na₂O, and K₂O is preferably from 0% to 3%, from 0% to 2%, from 0% to 1%, from 0% to 0.5%, from 0% to 0.2%, or from 0% to 0.1%, particularly preferably from 0.001% to less than 0.01%.

Alkaline earth metal oxides are components that reduce a liquidus temperature to make a devitrified crystal less liable to be generated in the glass, and are also components that enhance the meltability and the formability. The content of MgO+CaO+SrO+BaO is from 0% to 12%, preferably from 0% to 10%, from 0% to 8%, from 0% to 7%, from 1% to 7%, from 2% to 7%, or from 3% to 9%, particularly preferably from 3% to 6%. When the content of MgO+CaO+SrO+BaO is excessively small, devitrification resistance is liable to be reduced, and besides, their function as melting accelerate components cannot be sufficiently exhibited, with the result that the meltability is liable to be reduced. Meanwhile, when the content of MgO+CaO+SrO+BaO is excessively large, the density is increased to make it difficult to achieve the lightweighting of the glass, and besides, the thermal expansion coefficient is improperly increased, with the result that the thermal shock resistance is liable to be reduced.

MgO is a component that reduces the viscosity at high temperature to enhance the meltability without reducing a strain point, and is also a component that is least liable to increase the density among the alkaline earth metal oxides. The content of MgO is preferably from 0% to 12%, from 0% to 10%, from 0.01% to 8%, from 0.1% to 6%, from 0.2% to 5%, from 0.3% to 4%, or from 0.5% to 3%, particularly preferably from 1% to 2%. However, when the content of MgO is excessively large, the liquidus temperature is increased, and hence the devitrification resistance is liable to be reduced. In addition, the glass undergoes phase separation, and hence its transparency is liable to be reduced.

CaO is a component that reduces the viscosity at high temperature to remarkably enhance the meltability without reducing the strain point, and is also a component that has a great effect of enhancing the devitrification resistance in the glass composition system of the present invention. Accordingly, a suitable lower limit range of CaO is 0% or more, 0.05% or more, 0.1% or more, 1% or more, 1.1% or more, 1.2% or more, 1.3% or more, 1.4% or more, or 1.5% or more, particularly 2% or more. Meanwhile, when the content of CaO is excessively large, the thermal expansion coefficient and the density are improperly increased, and the glass composition loses its component balance, with the result that the devitrification resistance is liable to be reduced contrarily. Accordingly, a suitable upper limit range of CaO is 12% or less, 10% or less, 8% or less, 7% or less, 6% or less, 5% or less, 4.6% or less, 4.5% or less, 4.4% or less, or 4% or less, particularly 3% or less.

SrO is a component that reduces the viscosity at high temperature to enhance the meltability without reducing the strain point, but when the content of SrO is excessively large, a liquidus viscosity is liable to be reduced. Accordingly, the content of SrO is preferably from 0 to 10%, from 0% to 8%, from 0% to 7%, from 0% to 6%, from 0% to 5.1%, from 0% to 5%, from 0% to 4.9%, from 0% to 4%, from 0% to 3%, from 0% to 2%, from 0% to 1.5%, from 0% to 1%, or from 0% to 0.5%, particularly preferably from 0% to 0.1%.

BaO is a component that reduces the viscosity at high temperature to enhance the meltability without reducing the strain point, but when the content of BaO is excessively large, the liquidus viscosity is liable to be reduced. Accordingly, the content of BaO is preferably from 0% to 10%, from 0% to 8%, from 0% to 7%, from 0% to 6%, from 0% to 5%, from 0% to 4%, from 0% to 3%, from 0% to 2%, from 0% to 1.5%, from 0% to 1%, or from 0% to 0.5%, particularly preferably from 0% to less than 0.1%.

When a mass ratio (MgO+CaO+SrO+BaO)/(SiO₂+Al₂O₃+B₂O₃) is excessively large, the weather resistance is liable to be reduced, and besides, in the formation of through holes by etching, an etching rate tends to be increased to distort the shapes of the through holes. Further, also in the formation of through holes by laser irradiation, hole-making accuracy tends to be reduced. Meanwhile, when the mass ratio (MgO+CaO+SrO+BaO)/(SiO₂+Al₂O₃+B₂O₃) is excessively small, the viscosity at high temperature is increased to increase a melting temperature, and hence the manufacturing cost of the glass sheet is liable to rise. Accordingly, the mass ratio (MgO+CaO+SrO+BaO)/(SiO₂+Al₂O₃+B₂O₃) is preferably from 0.001 to 0.4, from 0.005 to 0.35, from 0.010 to 0.30, from 0.020 to 0.25, from 0.030 to 0.20, from 0.035 to 0.15, from 0.040 to 0.14, or from 0.045 to 0.13, particularly preferably from 0.050 to 0.10. The “mass ratio (MgO+CaO+SrO+BaO)/(SiO₂+Al₂O₃+B₂O₃)” refers to a value obtained by dividing the content of MgO+CaO+SrO+BaO by the content of SiO₂+Al₂O₃+B₂O₃.

When amass ratio (MgO+CaO+SrO+BaO)/Al₂O₃ is excessively small, the devitrification resistance is reduced to make it difficult to form a sheet shape by an overflow down-draw method. Meanwhile, when the mass ratio (MgO+CaO+SrO+BaO)/Al₂O₃ is excessively large, there is a risk in that the density and the thermal expansion coefficient may be improperly increased. Accordingly, the mass ratio (MgO+CaO+SrO+BaO)/Al₂O₃ is preferably from 0.1 to 1.5, from 0.1 to 1.2, from 0.2 to 1.2, from 0.3 to 1.2, or from 0.4 to 1.1, particularly preferably from 0.5 to 1.0. “(MgO+CaO+SrO+BaO)/Al₂O₃” refers to a value obtained by dividing the content of MgO+CaO+SrO+BaO by the content of Al₂O₃.

A mass ratio (SrO+BaO)/B₂O₃ is preferably 0.5 or less, 0.2 or less, 0.1 or less, 0.05 or less, or 0.03 or less, particularly preferably 0.02 or less. When the mass ratio (SrO+BaO)/B₂O₃ is excessively large, the low dielectric characteristics are difficult to secure, and besides, the liquidus viscosity is difficult to increase. “SrO+BaO” refers to the total content of SrO and BaO. In addition, “(SrO+BaO)/B₂O₃” refers to a value obtained by dividing the content of SrO+BaO by the content of B₂O₃.

A mass ratio B₂O₃/(SrO+BaO) is preferably 2 or more, 5 or more, 10 or more, 20 or more, 30 or more, or 40 or more, particularly preferably 50 or more. When the mass ratio (SrO+BaO)/B₂O₃ is excessively small, the low dielectric characteristics are difficult to secure, and besides, the liquidus viscosity is difficult to increase. “B₂O₃/(SrO+BaO)” refers to a value obtained by dividing the content of B₂O₃ by the content of SrO+BaO.

B₂O₃—(MgO+CaO+SrO+BaO) is preferably 5% or more, 6% or more, 7% or more, 8% or more, 9% or more, 10% or more, or 11% or more, particularly preferably 12% or more. When the content of B₂O₃—(MgO+CaO+SrO+BaO) is excessively small, the low dielectric characteristics are difficult to secure, and besides, the density is liable to be increased. In addition, the Young's modulus is liable to be reduced.

A mass ratio (SrO+BaO)/(MgO+CaO) is preferably 400 or less, 300 or less, 100 or less, 50 or less, 10 or less, 5 or less, 2 or less, 1 or less, 0.8 or less, or 0.5 or less, particularly preferably 0.3 or less. When the mass ratio (SrO+BaO)/(MgO+CaO) is excessively large, the low dielectric characteristics are difficult to secure, and besides, the density is liable to be increased.

In addition to the above-mentioned components, the following components may be introduced into the glass composition.

ZnO is a component that enhances the meltability, but when a large amount thereof is contained in the glass composition, the glass is liable to devitrify, and besides, the density is liable to be increased. Accordingly, the content of ZnO is preferably from 0% to 5%, from 0% to 3%, from 0% to 0.5%, or from 0% to 0.3%, particularly from 0% to 0.1%.

ZrO₂ is a component that increases the Young's modulus. The content of ZrO₂ is preferably from 0% to 5%, from 0% to 3%, from 0% to 0.5%, from 0% to 0.2%, from 0% to 0.16%, or from 0% to 0.1%, particularly preferably from 0% to 0.02%. When the content of ZrO₂ is excessively large, the liquidus temperature is increased, with the result that a devitrified crystal of zircon is liable to precipitate.

TiO₂ is a component that reduces the viscosity at high temperature to enhance the meltability, and is also a component that suppresses solarization, but when a large amount thereof is contained in the glass composition, the glass is liable to be colored to be reduced in transmittance. Accordingly, the content of TiO₂ is preferably from 0% to 5%, from 0% to 3%, from 0% to 1%, or from 0% to 0.1%, particularly preferably from 0% to 0.02%.

P₂O₅ is a component that enhances the devitrification resistance, but when a large amount thereof is contained in the glass composition, the glass is liable to undergo phase separation to opacify, and besides, there is a risk in that the water resistance may be remarkably reduced. Accordingly, the content of P₂O₅ is preferably from 0% to 5%, from 0% to 1%, or from 0% to 0.5%, particularly preferably from 0% to 0.1%.

SnO₂ is a component that has a satisfactory fining action in a high-temperature region, and is also a component that reduces the viscosity at high temperature. The content of SnO₂ is preferably from 0% to 1%, from 0.01% to 0.5%, or from 0.05% to 0.3%, particularly preferably from 0.1% to 0.3%. When the content of SnO₂ is excessively large, a devitrified crystal of SnO₂ is liable to precipitate in the glass.

Fe₂O₃ is an impurity component, or a component that may be introduced as a fining agent component. However, when the content of Fe₂O₃ is excessively large, there is a risk in that an ultraviolet light transmittance may be reduced. Accordingly, the content of Fe₂O₃ is preferably 0.05% or less, or 0.03% or less, particularly preferably 0.02% or less. Herein, the term “Fe₂O₃” as used in the present invention includes ferrous oxide and ferric oxide, and ferrous oxide is treated in terms of Fe₂O₃. Other oxides are also similarly treated with reference to indicated oxides.

SnO₂ is suitably added as a fining agent, but CeO₂, SO₃, C, or metal powder (e.g., Al or Si) may be added as a fining agent up to 1% as long as glass characteristics are not impaired.

As₂O₃, Sb₂O₃, F, and Cl each also effectively act as a fining agent, and the present invention does not exclude the incorporation of those components, but from an environmental point of view, the content of each of those components is preferably less than 0.1%, particularly preferably less than 0.05%.

The glass sheet of the present invention preferably has the following characteristics.

A specific dielectric constant at 25° C. and a frequency of 10 GHz is preferably 5.0 or less, 4.9 or less, 4.8 or less, 4.7 or less, or 4.6 or less, particularly preferably 4.5 or less. When the specific dielectric constant at 25° C. and a frequency of 10 GHz is excessively high, a transmission loss at the time of the transmission of an electrical signal to a high-frequency device is liable to be increased.

A dielectric dissipation factor at 25° C. and a frequency of 10 GHz is preferably 0.01 or less, 0.009 or less, 0.008 or less, 0.007 or less, 0.006 or less, 0.005 or less, or 0.004 or less, particularly preferably 0.003 or less. When the dielectric dissipation factor at 25° C. and a frequency of 10 GHz is excessively high, the transmission loss at the time of the transmission of an electrical signal to a high-frequency device is liable to be increased.

A specific dielectric constant at 25° C. and a frequency of 2.45 GHz is preferably 5.0 or less, 4.9 or less, 4.8 or less, 4.7 or less, or 4.6 or less, particularly preferably 4.5 or less. When the specific dielectric constant at 25° C. and a frequency of 10 GHz is excessively high, the transmission loss at the time of the transmission of an electrical signal to a high-frequency device is liable to be increased.

A dielectric dissipation factor at 25° C. and a frequency of 2.45 GHz is preferably 0.01 or less, 0.009 or less, 0.008 or less, 0.007 or less, 0.006 or less, 0.005 or less, or 0.004 or less, particularly preferably 0.003 or less. When the dielectric dissipation factor at 25° C. and a frequency of 10 GHz is excessively high, the transmission loss at the time of the transmission of an electrical signal to a high-frequency device is liable to be increased.

The Young's modulus is preferably 40 GPa or more, 41 GPa or more, 43 GPa or more, 45 GPa or more, 47 GPa or more, 50 GPa or more, 51 GPa or more, 52 GPa or more, 53 GPa or more, or 54 GPa or more, particularly preferably 55 GPa or more. When the Young's modulus is excessively low, the glass sheet is liable to be deflected, and hence wiring failure is liable to occur at the time of the production of a high-frequency device.

A thermal shrinkage rate in a case in which the glass sheet is increased in temperature at a rate of 5° C./min, kept at 500° C. for 1 hour, and decreased in temperature at a rate of 5° C./min is preferably 30 ppm or less, 25 ppm or less, or 20 ppm or less, particularly preferably 18 ppm or less. When the thermal shrinkage rate in a case in which the glass sheet is increased in temperature at a rate of 5° C./min, kept at 500° C. for 1 hour, and decreased in temperature at a rate of 5° C./min is excessively large, the glass sheet is liable to be thermally shrunk in a heat treatment step at the time of the production of a high-frequency device, and hence wiring failure is liable to occur at the time of the production of the high-frequency device.

The thermal expansion coefficient in a temperature range of from 30° C. to 380° C. is preferably from 20×10⁻⁷/° C. to 50×10⁻⁷/° C., from 22×10⁻⁷/° C. to 48×10⁻⁷/° C., from 23×10⁻⁷/° C. to 47×10⁻⁷/° C., from 25×10⁻⁷/° C. to 46×10⁻⁷/° C., from 28×10⁻⁷/° C. to 45×10⁻⁷/° C., from 30×10⁻⁷/° C. to 43×10⁻⁷/° C., or from 32×10⁻⁷/° C. to 41×10⁻⁷/° C., particularly preferably from 35×10⁻⁷/° C. to 39×10⁻⁷/° C. When the thermal expansion coefficient in a temperature range of from 30° C. to 380° C. falls outside the above-mentioned ranges, a low-expansion member, such as silicon, is difficult to bond to the glass sheet.

The thermal expansion coefficient in a temperature range of from 20° C. to 200° C. is preferably from 21×10⁻⁷/° C. to 51×10⁻⁷/° C., from 22×10⁻⁷/° C. to 48×10⁻⁷/° C., from 23×10⁻⁷/° C. to 47×10⁻⁷/° C., from 25×10⁻⁷/° C. to 46×10⁻⁷/° C., from 28×10⁻⁷/° C. to 45×10⁻⁷/° C., from 30×10⁻⁷/° C. to 43×10⁻⁷/° C., or from 32×10⁻⁷/° C. to 41×10⁻⁷/° C., particularly preferably from 35×10⁻⁷/° C. to 39×10⁻⁷/° C. When the thermal expansion coefficient in a temperature range of from 20° C. to 200° C. falls outside the above-mentioned ranges, a low-expansion member, such as silicon, is difficult to bond to the glass sheet.

The thermal expansion coefficient in a temperature range of from 20° C. to 220° C. is preferably from 21×10⁻⁷/° C. to 51×10⁻⁷/° C., from 22×10⁻⁷/° C. to 48×10⁻⁷/° C., from 23×10⁻⁷/° C. to 47×10⁻⁷/° C., from 25×10⁻⁷/° C. to 46×10⁻⁷/° C., from 28×10⁻⁷/° C. to 45×10⁻⁷/° C., from 30×10⁻⁷/° C. to 43×10⁻⁷/° C., or from 32×10⁻⁷/° C. to 41×10⁻⁷/° C., particularly preferably from 35×10⁻⁷/° C. to 39×10⁻⁷/° C. When the thermal expansion coefficient in a temperature range of from 20° C. to 220° C. falls outside the above-mentioned ranges, a low-expansion member, such as silicon, is difficult to bond to the glass sheet.

The thermal expansion coefficient in a temperature range of from 20° C. to 260° C. is preferably from 21×10⁻⁷/° C. to 51×10⁻⁷/° C., from 22×10⁻⁷/° C. to 48×10⁻⁷/° C., from 23×10⁻⁷/° C. to 47×10⁻⁷/° C., from 25×10⁻⁷/° C. to 46×10⁻⁷/° C., from 28×10⁻⁷/° C. to 45×10⁻⁷/° C., from 30×10⁻⁷/° C. to 43×10⁻⁷/° C., or from 32×10⁻⁷/° C. to 41×10⁻⁷/° C., particularly preferably from 35×10⁻⁷/° C. to 39×10⁻⁷/° C. When the thermal expansion coefficient in a temperature range of from 20° C. to 260° C. falls outside the above-mentioned ranges, a low-expansion member, such as silicon, is difficult to bond to the glass sheet.

The thermal expansion coefficient in a temperature range of from 20° C. to 300° C. is preferably from 20×10⁻⁷/° C. to 50×10⁻⁷/° C., from 22×10⁻⁷/° C. to 48×10⁻⁷/° C., from 23×10⁻⁷/° C. to 47×10⁻⁷/° C., from 25×10⁻⁷/° C. to 46×10⁻⁷/° C., from 28×10⁻⁷/° C. to 45×10⁻⁷/° C., from 30×10⁻⁷/° C. to 43×10⁻⁷/° C., or from 32×10⁻⁷/° C. to 41×10⁻⁷/° C., particularly preferably from 35×10⁻⁷/° C. to 39×10⁻⁷/° C. When the thermal expansion coefficient in a temperature range of from 20° C. to 300° C. falls outside the above-mentioned ranges, a low-expansion member, such as silicon, is difficult to bond to the glass sheet.

The difference between the thermal expansion coefficient in a temperature range of from 20° C. to 300° C. and the thermal expansion coefficient in a temperature range of from 20° C. to 200° C. is preferably from 1.0×10⁻⁷/° C. or less, more preferably −1.0×10⁻⁷/° C. or more and 0.9×10⁻⁷/° C. or less, −0.8×10⁻⁷/° C. or more and 0.7×10⁻⁷/° C. or less, −0.6×10⁻⁷/° C. or more and 0.5×10⁻⁷/° C. or less, or −0.4×10⁻⁷/° C. or more and 0.3×10⁻⁷/° C. or less, particularly preferably −0.3×10⁻⁷/° C. or more and 0.2×10⁻⁷/° C. or less. When the difference between the thermal expansion coefficient in a temperature range of from 20° C. to 300° C. and the thermal expansion coefficient in a temperature range of from 20° C. to 200° C. is large, at the time of a change in heat treatment temperature in the manufacturing process of a high-frequency device, a change in thermal expansion coefficient of the glass sheet is increased to increase the warpage of the high-frequency device due to a difference in thermal expansion coefficient from a low-expansion member, such as silicon, bonded to the glass sheet.

An external transmittance at a wavelength of 1,100 nm in terms of a thickness of 1.0 mm is preferably 85% or more, 86% or more, 87% or more, 88% or more, 89% or more, or 90% or more, particularly preferably 91% or more. When the external transmittance at a wavelength of 1,100 nm in terms of a thickness of 1.0 mm falls outside the above-mentioned ranges, for example, in the case where a resin layer or high-frequency device bonded to the front surface of the glass sheet is peeled off or cured by being irradiated with an infrared laser or the like from the back surface side of the glass sheet, there is an increased risk in that the peeling or the curing may be unsuccessful, resulting in a product defect.

An external transmittance at a wavelength of 355 nm in terms of a thickness of 1.0 mm is preferably 80% or more, 81% or more, 82% or more, 83% or more, 84% or more, or 85% or more, particularly preferably 86% or more. When the external transmittance at a wavelength of 355 nm in terms of a thickness of 1.0 mm falls outside the above-mentioned ranges, for example, in the case where a resin layer or high-frequency device bonded to the front surface of the glass sheet is peeled off or cured by being irradiated with an ultraviolet laser or the like from the back surface side of the glass sheet, there is an increased risk in that the peeling or the curing may be unsuccessful, resulting in a product defect.

An external transmittance at a wavelength of 265 nm in terms of a thickness of 1.0 mm is preferably 15% or more, 16% or more, 17% or more, 18% or more, 20% or more, or 22% or more, particularly preferably 23% or more. When the external transmittance at a wavelength of 265 nm in terms of a thickness of 1.0 mm falls outside the above-mentioned ranges, for example, in the case where a resin layer or high-frequency device bonded to the front surface of the glass sheet is peeled off or cured by being irradiated with a mercury lamp or the like from the back surface side of the glass sheet, there is an increased risk in that the peeling or the curing may be unsuccessful, resulting in a product defect.

The liquidus viscosity is preferably 10^{3.9} dPa·s or more, 10^{4.0} dPa·s or more, 10^{4.2} dPa·s or more, 10^{4.6} dPa·s or more, 10^{4.8} dPa·s or more, or 10^{5.0} dPa·s or more, particularly preferably 10^{5.2} dPa·s or more. When the liquidus viscosity is excessively low, the glass is liable to devitrify at the time of forming.

The strain point is preferably 480° C. or more, 500° C. or more, 520° C. or more, 530° C. or more, 540° C. or more, 550° C. or more, 560° C. or more, 570° C. or more, or 580° C. or more, particularly preferably 590° C. or more. When the strain point is excessively low, the glass sheet is liable to be thermally shrunk in a heat treatment step at the time of the production of a high-frequency device, and hence wiring failure is liable to occur at the time of the production of the high-frequency device.

A β-OH value is preferably 1.1 mm⁻¹, or less, 0.6 mm⁻¹ or less, 0.55 mm⁻¹ or less, 0.5 mm⁻¹ or less, 0.45 mm⁻¹ or less, 0.4 mm⁻¹ or less, 0.35 mm⁻¹ or less, 0.3 mm⁻¹ or less, 0.25 mm⁻¹ or less, 0.2 mm⁻¹ or less, or 0.15 mm⁻¹ or less, particularly preferably 0.1 mm⁻¹ or less. When the β-OH value is excessively large, the low dielectric characteristics are difficult to secure. The “β-OH value” is a value calculated by the following equation using FT-IR.

$$β \text{-} OH value = ( 1 / X ) log ( {T}_{1} / {T}_{2} )$$

X: Thickness (mm)

T₁: Transmittance (%) at a reference wavelength of 3,846 cm⁻¹

T₂: Minimum transmittance (%) at a wavelength around a hydroxyl group absorption wavelength of 3,600 cm⁻¹

A fracture toughness K_{1C} is preferably 0.6 MPa·m^{0.5} or more, 0.62 MPa·m^{0.5} or more, 0.65 MPa·m^{0.5} or more, 0.67 MPa·m^{0.5} or more, or 0.69 MPa·m^{0.5} or more, particularly preferably 0.7 MPa·m^{0.5} or more. When the fracture toughness K_{1C} is excessively low, at the time of the production of a high-frequency device, the glass sheet is liable to broken through extension of a crack upon application of a tensile stress around the through holes. The “fracture toughness K_{1C}” is measured using a Single-Edge-Precracked-Beam method (SEPB method) on the basis of “Testing methods for fracture toughness of fine ceramics at room temperature” of JIS R1607. The SEPB method is a method involving subjecting a precracked specimen to a three-point bending fracture test to measure the maximum load before fracture of the specimen, and determining a plane-strain fracture toughness K_{1C} from the maximum load, the length of the preformed crack, the dimensions of the specimen, and a distance between bending fulcrums. The measured value of the fracture toughness K_{1C} of each glass is an average value of five measurements.

A volume resistivity Log ρ at 25° C. is preferably 16 Ω·cm or more, 16.5 Ω·cm or more, or 17 Ω·cm or more, particularly preferably 17.5 Ω·cm or more. When the volume resistivity Log ρ at 25° C. is excessively low, a transmission signal is liable to flow to the glass sheet side, and hence the transmission loss at the time of the transmission of an electrical signal to a high-frequency device is liable to be increased. The “volume resistivity Log ρ at 25° C.” refers to a value measured on the basis of ASTM C657-78.

A thermal conductivity at 25° C. is preferably 0.7 W/(m·K) or more, 0.75 W/(m·K) or more, 0.8 W/(m·K) or more, or 0.85 W/(m·K) or more, particularly preferably 0.9 W/(m·K) or more. When the thermal conductivity at 25° C. is excessively low, the heat dissipating property of the glass sheet is reduced, and hence there is a risk in that the glass sheet may undergo an excessive temperature increase during the operation of a high-frequency device. The “thermal conductivity at 25° C.” refers to a value measured on the basis of JIS R2616.

A water vapor transmission rate is preferably 1×10⁻¹ g/(m²·24 h) or less, 1×10⁻² g/(m²·24 h) or less, 1×10⁻³ g/(m²·24 h) or less, or 1×10⁻⁴ g/(m²·24 h) or less, particularly preferably 1×10⁻⁵ g/(m²·24 h) or less. When the water vapor transmission rate is excessively high, the glass sheet is liable to trap water vapor, and hence the low dielectric characteristics are difficult to maintain. The “water vapor transmission rate” may be measured by a known calcium method.

The glass sheet of the present invention preferably has a through hole formed in a thickness direction, and more preferably has a plurality of through holes formed in the thickness direction. In addition, from the viewpoint of increasing a wiring density, the average inner diameter of the through holes is preferably 300 μm or less, 280 μm or less, 250 μm or less, 230 μm or less, 200 μm or less, 180 μm or less, 150 μm or less, 130 μm or less, 120 μm or less, 110 μm or less, or 100 μm or less, particularly preferably 90 μm or less. However, when the average inner diameter of the through holes is excessively small, a wiring structure configured to establish conduction between both surfaces of the glass sheet is difficult to form. Accordingly, the average inner diameter of the through holes is preferably 10 μm or more, 20 μm or more, 30 μm or more, or 40 μm or more, particularly preferably 50 μm or more.

A difference between the maximum value and the minimum value of the inner diameters of the through holes is preferably 50 μm or less, 45 μm or less, 40 μm or less, 35 μm or less, or 30 μm or less, particularly preferably 25 μm or less. When the difference between the maximum value and the minimum value of the inner diameters of the through holes is excessively large, the length of wiring configured to establish conduction between both surfaces of the glass sheet is unnecessarily increased, and hence the transmission loss is difficult to reduce.

The maximum length of a crack in a surface direction extending from the through holes is preferably 100 μm or less, 50 μm or less, 30 μm or less, 10 μm or less, 5 μm or less, 3 μm or less, or 1 μm or less, particularly preferably 0.5 μm or less. When the maximum length of a crack in a surface direction extending from the through holes is excessively large, at the time of the production of a high-frequency device, the glass sheet is liable to be broken through extension of the crack upon application of a tensile stress around the through holes.

A warpage level is preferably 100 μm or less, 90 μm or less, or 80 μm or less, particularly preferably 70 μm or less. When the warpage level is excessively large, wiring failure is liable to occur at the time of the production of a high-frequency device.

A total thickness variation is preferably 5 μm or less, 4.8 μm or less, 4.5 μm or less, 4.3 μm or less, 4 μm or less, or 3.5 μm or less, particularly preferably 3 μm or less. When the total thickness variation is excessively large, wiring failure is liable to occur at the time of the production of a high-frequency device. The “warpage level” and the “total thickness variation” are values measured with Bow/Warp measurement apparatus SBW-331ML/d manufactured by Kobelco Research Institute, Inc.

The shape of the glass sheet is preferably a rectangular shape or a circular shape. With this configuration, its application to the manufacturing process of a printed wiring board or a semiconductor is facilitated. In the case of the rectangular shape, the dimensions of the glass sheet of the present invention are preferably 300 mm×400 mm or more, 305 mm×405 mm or more, 310 mm×410 mm or more, 315 mm×415 mm or more, or 320 mm×420 mm or more, particularly preferably 325 mm×425 mm or more. When the dimensions of the glass sheet are excessively small, multi-chamfering is difficult in the manufacturing process of a high-frequency device, and hence the manufacturing cost of the high-frequency device is liable to rise. In the case of the circular shape, the dimension of the glass sheet of the present invention is φ500 mm or less, φ460 mm or less, or φ400 mm or less, particularly φ310 mm or less. In the case of the circular shape, when the dimension is excessively large, it is difficult to apply the glass sheet to, for example, a 6-inch semiconductor process, an 8-inch semiconductor process, a 12-inch semiconductor process, or an 18-inch semiconductor process in the manufacturing process of a high-frequency device.

The glass sheet of the present invention is preferably given individual identification information. With this configuration, in the manufacturing process of a high-frequency device, the manufacturing history and the like of individual glass sheets can be identified, and hence an investigation of the cause of a product defect can be easily performed. As a method of giving the glass sheet individual identification information, there are given, for example, a known laser ablation method (evaporation of glass through irradiation with a pulsed laser), barcode printing, and QR code (trademark) printing.

The thickness of the glass sheet of the present invention is preferably 10 mm or less, 9 mm or less, 8 mm or less, 7 mm or less, 6 mm or less, 5 mm or less, 4 mm or less, 3 mm or less, 2 mm or less, 1 mm or less, 0.9 mm or less, 0.8 mm or less, 0.7 mm or less, 0.6 mm or less, 0.5 mm or less, or 0.4 mm or less, particularly preferably 0.3 mm or less. When the thickness is excessively large, the lightweighting and downsizing of a high-frequency device are difficult.

The glass sheet of the present invention is preferably formed by an overflow down-draw method. With this configuration, a glass sheet having satisfactory surface quality in an unpolished state can be efficiently obtained. Other than the overflow down-draw method, various forming methods may be adopted. For example, forming methods such as a slot down method, a float method, and a roll-out method may be adopted.

From the viewpoint of reducing the resistance loss of a high-frequency device, the arithmetic average roughness Ra of the surface of the glass sheet is preferably 100 nm or less, 50 nm or less, 20 nm or less, 10 nm or less, 5 nm or less, 2 nm or less, or 1 nm or less, particularly preferably 0.5 nm or less. When the arithmetic average roughness Ra of the surface of the glass sheet is excessively large, the arithmetic average roughness Ra of metal wiring to be formed on the surface of the glass sheet is increased, and hence a resistance loss due to a so-called skin effect, which occurs when a current is caused to flow through the metal wiring of a high-frequency device, becomes excessive. In addition, the glass sheet is reduced in strength, and hence is liable to be broken.

In addition, from the viewpoint of increasing the manufacturing yield of a high-frequency device, the arithmetic average roughness Ra of the surface of the glass sheet is preferably 1 nm or more, 1.3 nm or more, 1.4 nm or more, 1.5 nm or more, 1.6 nm or more, 1.8 nm or more, 2 nm or more, 4 nm or more, 8 nm or more, 11 nm or more, 15 nm or more, 25 nm or more, 40 nm or more, 60 nm or more, 90 nm or more, 110 nm or more, 200 nm or more, or 300 nm or more, particularly preferably 400 nm or more. When the arithmetic average roughness Ra of the surface of the glass sheet is excessively small, metal wiring to be formed on the surface of the glass sheet and a coating layer covering the surface of the glass sheet are liable to be peeled off. As a result, the manufacturing yield of the high-frequency device is improved. The “arithmetic average roughness Ra” may be measured with a stylus-type surface roughness meter or an atomic force microscope (AFM).

The glass sheet of the present invention preferably does not have a surface compressive stress layer formed through ion exchange. With this configuration, the manufacturing cost of the glass sheet can be easily reduced.

The glass sheet of the present invention is preferably used in the manufacturing process of a high-frequency device, and is more preferably used in a semi-additive process. When the semi-additive process is adopted, the wiring width of the high-frequency device can be adjusted to the width required of the device.

In addition, the glass sheet of the present invention is preferably used in a process involving forming passive components on the surface of the glass sheet. In addition, the passive components preferably include at least one or more kinds of a capacitor, a coil, and a resistor, and for example, a module for an RF front end for a smartphone is preferred.

In the manufacturing process of a high-frequency device, the highest treatment temperature is preferably 350° C. or less, 345° C. or less, 340° C. or less, 335° C. or less, or 330° C. or less, particularly preferably 325° C. or less. When the highest treatment temperature is excessively high, the reliability of the high-frequency device is liable to be reduced.

### Example 1

Now, the present invention is described in detail based on Examples. The following Examples are merely illustrative. The present invention is by no means limited to the following Examples.

Examples of the present invention (Samples No. 1 to 104) are shown in Tables 1 to 13. [Unmeasured] in each of the tables means that no measurement has been performed.

TABLE 1

| | | No. 1 | No. 2 | No. 3 | No. 4 |
|---|---|---|---|---|---|
| Composition | SiO₂ | 63.41 | 58.02 | 67.14 | 61.39 |
| (mass %) | Al₂O₃ | 6.5 | 12.7 | 6.5 | 12.7 |
| | B₂O₃ | 25.2 | 24.5 | 21.4 | 21.1 |
| | Na₂O | 0.02 | 0.02 | 0.02 | 0.02 |
| | K₂O | 0.002 | 0.002 | 0.002 | 0.002 |
| | MgO | 1.94 | 1.90 | 1.95 | 1.90 |
| | CaO | 2.69 | 2.62 | 2.70 | 2.62 |
| | SrO | 0.02 | 0.01 | 0.03 | 0.02 |
| | BaO | 0.00 | 0.00 | 0.00 | 0.00 |
| | ZrO₂ | 0.01 | 0.02 | 0.05 | 0.04 |
| | TiO₂ | 0.000 | 0.000 | 0.000 | 0.000 |
| | SnO₂ | 0.20 | 0.20 | 0.20 | 0.20 |
| | Fe₂O₃ | 0.004 | 0.005 | 0.004 | 0.005 |
| Mg + Ca + Sr + Ba | | 4.65 | 4.53 | 4.68 | 4.54 |
| (Mg + Ca + Sr + Ba)/Al | | 0.72 | 0.36 | 0.72 | 0.36 |
| B − (Mg + Ca + Sr + Ba) | | 20.6 | 20.0 | 16.7 | 16.6 |
| (Mg + Ca + Sr + Ba)/ | | 0.049 | 0.048 | 0.049 | 0.048 |
| (Si + Al + B) | | | | | |
| B − Al | | 18.7 | 11.8 | 14.9 | 8.4 |
| Li + Na + K | | 0.022 | 0.022 | 0.022 | 0.022 |
| (Sr + Ba)/B | | 0.001 | 0.000 | 0.001 | 0.001 |
| B/(Sr + Ba) | | 1,260 | 2,450 | 713 | 1,055 |
| (Sr + Ba)/(Mg + Ca) | | 0.004 | 0.002 | 0.006 | 0.004 |
| ρ [g/cm³] | | 2.18 | 2.23 | 2.20 | 2.24 |
| ∝ (20° C. to 200° C.) | | 32.8 | 31.7 | 30.0 | 28.9 |
| [×10⁻⁷/° C.] | | | | | |
| ∝ (20° C. to 220° C.) | | 32.7 | 31.8 | 30.0 | 28.9 |
| [×10⁻⁷/° C.] | | | | | |
| ∝ (20° C. to 260° C.) | | 32.5 | 31.8 | 29.8 | 29.0 |
| [×10⁻⁷/° C.] | | | | | |
| ∝ (20° C. to 300° C.) | | 32.3 | 31.8 | 29.6 | 29.0 |
| [×10⁻⁷/° C.] | | | | | |
| ∝ (30° C. to 380° C.) | | 31.7 | 31.7 | 29.2 | 29.0 |
| [×10⁻⁷/° C.] | | | | | |
| ∝ (20° C. to 300° C.) − ∝ (20° C. to | | −0.5 | 0.1 | −0.4 | 0.1 |
| 200° C.) [×10⁻⁷/° C.] | | | | | |
| Ps [° C.] | | 551 | 575 | 570 | 604 |
| Ta [° C.] | | 611 | 636 | 644 | 664 |
| Ts [° C.] | | Unmeasured | Unmeasured | Unmeasured | Unmeasured |
| 10^{4.0} dPa · s [° C.] | | 1,303 | 1,233 | 1,356 | 1,279 |
| 10^{3.0} dPa · s [° C.] | | 1,499 | 1,405 | 1,556 | 1,457 |
| 10^{2.5} dPa · s [° C.] | | 1,620 | 1,513 | 1,680 | 1,569 |
| E [GPa] | | 51 | 56 | 54 | 59 |
| TL [° C.] | | 1,060 | Unmeasured | 1,068 | Unmeasured |
| logηTL [dPa · s] | | 5.9 | Unmeasured | 6.5 | Unmeasured |
| β − OH [mm⁻¹] | | Unmeasured | 0.27 | 0.46 | 0.27 |
| Transmittance at 265 nm | | Unmeasured | Unmeasured | Unmeasured | Unmeasured |
| and thickness of 1 mm [%] | | | | | |
| Transmittance at 305 nm | | Unmeasured | Unmeasured | Unmeasured | Unmeasured |
| and thickness of 1 mm [%] | | | | | |
| Transmittance at 355 nm | | Unmeasured | Unmeasured | Unmeasured | Unmeasured |
| and thickness of 1 mm [%] | | | | | |
| Transmittance at 365 nm | | Unmeasured | Unmeasured | Unmeasured | Unmeasured |
| and thickness of 1 mm [%] | | | | | |
| Transmittance at 1,100 nm | | Unmeasured | Unmeasured | Unmeasured | Unmeasured |
| and thickness of 1 mm [%] | | | | | |
| Specific dielectric | | 4.09 | 4.30 | 4.13 | 4.33 |
| constant (25° C., 2.45 GHz) | | | | | |
| Dielectric dissipation | | 0.00092 | 0.00126 | 0.00098 | 0.00132 |
| factor (25° C., 2.45 GHz) | | | | | |
| Specific dielectric | | Unmeasured | Unmeasured | Unmeasured | Unmeasured |
| constant (25° C., 10 GHz) | | | | | |
| Dielectric dissipation | | Unmeasured | Unmeasured | Unmeasured | Unmeasured |
| factor (25° C., 10 GHz) | | | | | |
| Processing accuracy of | | ∘ | ∘ | ∘ | ∘ |
| through holes | | | | | |
| | | No. 5 | No. 6 | No. 7 | No. 8 |
| Composition | SiO₂ | 56.14 | 70.92 | 65.83 | 59.84 |
| (mass %) | Al₂O₃ | 18.5 | 6.5 | 12.8 | 18.6 |
| | B₂O₃ | 20.7 | 17.6 | 16.6 | 16.8 |
| | Na₂O | 0.02 | 0.03 | 0.02 | 0.02 |
| | K₂O | 0.003 | 0.004 | 0.004 | 0.003 |
| | MgO | 1.84 | 1.94 | 1.90 | 1.85 |
| | CaO | 2.55 | 2.68 | 2.63 | 2.56 |
| | SrO | 0.00 | 0.03 | 0.02 | 0.01 |
| | BaO | 0.00 | 0.00 | 0.00 | 0.00 |
| | ZrO₂ | 0.03 | 0.07 | 0.00 | 0.10 |
| | TiO₂ | 0.000 | 0.000 | 0.000 | 0.000 |
| | SnO₂ | 0.21 | 0.22 | 0.19 | 0.21 |
| | Fe₂O₃ | 0.005 | 0.004 | 0.005 | 0.005 |

| | | | | |
|---|---|---|---|---|
| Mg + Ca + Sr + Ba | 4.39 | 4.65 | 4.55 | 4.42 |
| (Mg + Ca + Sr + Ba)/Al | 0.24 | 0.72 | 0.36 | 0.24 |
| B − (Mg + Ca + Sr + Ba) | 16.3 | 13.0 | 12.1 | 12.4 |
| (Mg + Ca + Sr + Ba)/ | 0.046 | 0.049 | 0.048 | 0.046 |
| (Si + Al + B) | | | | |
| B − Al | 2.2 | 11.1 | 3.8 | −1.8 |
| Li + Na + K | 0.023 | 0.034 | 0.024 | 0.023 |
| (Sr + Ba)/B | 0.000 | 0.002 | 0.001 | 0.001 |
| B/(Sr + Ba) | ∞ | 587 | 830 | 1,680 |
| (Sr + Ba)/(Mg + Ca) | 0.000 | 0.006 | 0.004 | 0.002 |
| ρ [g/cm³] | 2.29 | 2.21 | 2.26 | 2.30 |
| ∝ (20° C. to 200° C.) | 29.4 | 27.1 | 26.2 | 26.5 |
| [×10⁻⁷/° C.] | | | | |
| ∝ (20° C. to 220° C.) | 29.5 | 27.1 | 26.3 | 26.7 |
| [×10⁻⁷/° C.] | | | | |
| ∝ (20° C. to 260° C.) | 29.8 | 27.0 | 26.4 | 27.0 |
| [×10⁻⁷/° C.] | | | | |
| ∝ (20° C. to 300° C.) | 30.0 | 26.8 | 26.5 | 27.2 |
| [×10⁻⁷/° C.] | | | | |
| ∝ (30° C. to 380° C.) | 30.3 | 26.4 | 26.5 | 27.7 |
| [×10⁻⁷/° C.] | | | | |
| ∝ (20° C. to 300° C.) − ∝ (20° C. to | 0.6 | −0.3 | 0.3 | 0.7 |
| 200° C.) [×10⁻⁷/° C.] | | | | |
| Ps [° C.] | 606 | 611 | 635 | 644 |
| Ta [° C.] | 674 | 696 | 699 | 718 |
| Ts [° C.] | 1,036 | Unmeasured | Unmeasured | 1,041 |
| 10^{4.0} dPa · s [° C.] | 1,242 | 1,421 | 1,335 | 1,270 |
| 10^{3.0} dPa · s [° C.] | 1,376 | 1,622 | 1,518 | 1,428 |
| 10^{2.5} dPa · s [° C.] | 1,476 | 1,756 | 1,634 | 1,529 |
| E [GPa] | 64 | 57 | 62 | 67 |
| TL [° C.] | Unmeasured | 1,074 | 1,216 or more | Unmeasured |
| logηTL [dPa · s] | Unmeasured | 7.2 | 5.0 or less | Unmeasured |
| β − OH [mm⁻¹] | 0.17 | 0.43 | 0.26 | 0.20 |
| Transmittance at 265 nm | Unmeasured | Unmeasured | Unmeasured | Unmeasured |
| and thickness of 1 mm [%] | | | | |
| Transmittance at 305 nm | Unmeasured | Unmeasured | Unmeasured | Unmeasured |
| and thickness of 1 mm [%] | | | | |
| Transmittance at 355 nm | Unmeasured | Unmeasured | Unmeasured | Unmeasured |
| and thickness of 1 mm [%] | | | | |
| Transmittance at 365 nm | Unmeasured | Unmeasured | Unmeasured | Unmeasured |
| and thickness of 1 mm [%] | | | | |
| Transmittance at 1,100 nm | Unmeasured | Unmeasured | Unmeasured | Unmeasured |
| and thickness of 1 mm [%] | | | | |
| Specific dielectric | 4.54 | 4.17 | 4.36 | 4.56 |
| constant (25° C., 2.45 GHz) | | | | |
| Dielectric dissipation | 0.00162 | 0.00109 | 0.00145 | 0.00178 |
| factor (25° C., 2.45 GHz) | | | | |
| Specific dielectric | Unmeasured | Unmeasured | Unmeasured | Unmeasured |
| constant (25° C., 10 GHz) | | | | |
| Dielectric dissipation | Unmeasured | Unmeasured | Unmeasured | Unmeasured |
| factor (25° C., 10 GHz) | | | | |
| Processing accuracy of | ∘ | ∘ | ∘ | ∘ |
| through holes | | | | |

TABLE 2

| | | No. 9 | No. 10 | No. 11 | No. 12 |
|---|---|---|---|---|---|
| Composition | SiO₂ | 63.15 | 57.73 | 66.40 | 61.27 |
| (mass) | Al₂O₃ | 6.5 | 12.5 | 6.5 | 12.6 |
| | B₂O₃ | 24.9 | 24.5 | 21.7 | 20.9 |
| | Na₂O | 0.02 | 0.02 | 0.02 | 0.02 |
| | K₂O | 0.003 | 0.003 | 0.003 | 0.003 |
| | MgO | 0.65 | 0.63 | 0.65 | 0.63 |
| | CaO | 4.45 | 4.32 | 4.42 | 4.33 |
| | SrO | 0.02 | 0.01 | 0.03 | 0.02 |
| | BaO | 0.00 | 0.00 | 0.00 | 0.00 |
| | ZrO₂ | 0.09 | 0.08 | 0.06 | 0.01 |
| | TiO₂ | 0.000 | 0.000 | 0.000 | 0.001 |
| | SnO₂ | 0.21 | 0.20 | 0.21 | 0.21 |
| | Fe₂O₃ | 0.004 | 0.004 | 0.004 | 0.005 |
| Mg + Ca + Sr + Ba | | 5.12 | 4.96 | 5.10 | 4.98 |
| (Mg + Ca + Sr + Ba)/Al | | 0.79 | 0.40 | 0.78 | 0.40 |
| B-(Mg + Ca + Sr + Ba) | | 19.8 | 19.5 | 16.6 | 15.9 |
| (Mg + Ca + Sr + Ba)/(Si + Al + B) | | 0.054 | 0.052 | 0.054 | 0.053 |
| B − Al | | 18.4 | 12.0 | 15.2 | 8.3 |
| Li + Na + K | | 0.023 | 0.023 | 0.023 | 0.023 |
| (Sr + Ba)/B | | 0.001 | 0.000 | 0.001 | 0.001 |
| B/(Sr + Ba) | | 1,245 | 2,450 | 723 | 1,045 |
| (Sr + Ba)/(Mg + Ca) | | 0.004 | 0.002 | 0.006 | 0.004 |
| ρ [g/cm³] | | 2.20 | 2.23 | 2.21 | 2.24 |
| ∝ (20° C. to 200° C.) | | 33.1 | 32.3 | 30.7 | 29.4 |
| [×10⁻⁷/° C.] | | | | | |
| ∝ (20° C. to 220° C.) | | 33.1 | 32.4 | 30.7 | 29.5 |
| [×10⁻⁷/° C.] | | | | | |
| ∝ (20° C. to 260° C.) | | 32.9 | 32.4 | 30.6 | 29.6 |
| [×10⁻⁷/° C.] | | | | | |
| ∝ (20° C. to 300° C.) | | 32.7 | 32.4 | 30.4 | 29.7 |
| [×10⁻⁷/° C.] | | | | | |
| ∝ (30° C. to 380° C.) | | 32.2 | 32.3 | 29.9 | 29.7 |
| [×10⁻⁷/° C.] | | | | | |
| ∝ (20° C. to 300° C.) − ∝ (20° C. to | | −0.4 | 0.1 | -0.4 | 0.3 |
| 200° C.) [×10⁻⁷/° C.] | | | | | |
| Ps [° C.] | | 551 | 573 | 576 | 596 |
| Ta [° C.] | | 613 | 629 | 646 | 653 |
| Ts [° C.] | | Unmeasured | Unmeasured | Unmeasured | Unmeasured |
| 10^{4.0} dPa · s [° C.] | | 1,288 | 1,238 | 1,346 | 1,281 |
| 10^{3.0} dPa · s [° C.] | | 1,487 | 1,412 | 1,548 | 1,459 |
| 10^{2.5} dPa · s [° C.] | | 1,611 | 1,523 | 1,672 | 1,570 |
| E [GPa] | | 52 | 56 | 55 | 58 |
| TL [° C.] | | 1,017 | 1,196 | 1,053 | 1,214 |
| logηTL [dPa · s] | | 6.3 | 4.3 | 6.5 | 4.5 |
| β − OH [mm⁻¹] | | Unmeasured | 0.26 | 0.45 | 0.30 |
| Transmittance at 265 nm | | Unmeasured | Unmeasured | Unmeasured | Unmeasured |
| and thickness of 1 mm [%] | | | | | |
| Transmittance at 305 nm | | Unmeasured | Unmeasured | Unmeasured | Unmeasured |
| and thickness of 1 mm [%] | | | | | |
| Transmittance at 355 nm | | Unmeasured | Unmeasured | Unmeasured | Unmeasured |
| and thickness of 1 mm [%] | | | | | |
| Transmittance at 365 nm | | Unmeasured | Unmeasured | Unmeasured | Unmeasured |
| and thickness of 1 mm [%] | | | | | |
| Transmittance at 1,100 nm | | Unmeasured | Unmeasured | Unmeasured | Unmeasured |
| and thickness of 1 mm [%] | | | | | |
| Specific dielectric | | 4.17 | 4.36 | 4.20 | 4.38 |
| constant (25° C., 2.45GHz) | | | | | |
| Dielectric dissipation | | 0.00096 | 0.00125 | 0.00105 | 0.00135 |
| factor (25° C., 2.45 GHz) | | | | | |
| Specific dielectric | | Unmeasured | Unmeasured | Unmeasured | Unmeasured |
| constant (25° C., 10 GHz) | | | | | |
| Dielectric dissipation | | Unmeasured | Unmeasured | Unmeasured | Unmeasured |
| factor (25° C., 10 GHz) | | | | | |
| Processing accuracy of | | ∘ | ∘ | ∘ | ∘ |
| through holes | | | | | |
| | | No. 13 | No. 14 | No. 15 | No. 16 |
| Composition | SiO₂ | 55.91 | 70.28 | 65.71 | 59.66 |
| (mass) | Al₂O₃ | 18.4 | 6.5 | 12.7 | 18.4 |
| | B₂O₃ | 20.6 | 17.9 | 16.3 | 16.8 |
| | Na₂O | 0.02 | 0.02 | 0.02 | 0.02 |
| | K₂O | 0.002 | 0.004 | 0.003 | 0.002 |
| | MgO | 0.60 | 0.65 | 0.62 | 0.61 |
| | CaO | 4.23 | 4.42 | 4.36 | 4.22 |
| | SrO | 0.00 | 0.03 | 0.02 | 0.01 |
| | BaO | 0.00 | 0.00 | 0.00 | 0.00 |
| | ZrO₂ | 0.03 | 0.01 | 0.08 | 0.06 |
| | TiO₂ | 0.000 | 0.000 | 0.000 | 0.000 |
| | SnO₂ | 0.20 | 0.22 | 0.18 | 0.21 |
| | Fe₂O₃ | 0.005 | 0.004 | 0.005 | 0.005 |

| | | | | |
|---|---|---|---|---|
| Mg + Ca + Sr + Ba | 4.83 | 5.10 | 5.00 | 4.84 |
| (Mg + Ca + Sr + Ba)/Al | 0.26 | 0.79 | 0.39 | 0.26 |
| B-(Mg + Ca + Sr + Ba) | 15.8 | 12.8 | 11.3 | 12.0 |
| (Mg + Ca + Sr + Ba)/(Si + Al + B) | 0.051 | 0.054 | 0.053 | 0.051 |
| B − Al | 2.2 | 11.4 | 3.6 | −1.6 |
| Li + Na + K | 0.022 | 0.024 | 0.023 | 0.022 |
| (Sr + Ba)/B | 0.000 | 0.002 | 0.001 | 0.001 |
| B/(Sr + Ba) | ∞ | 597 | 815 | 1,680 |
| (Sr + Ba)/(Mg + Ca) | 0.000 | 0.006 | 0.004 | 0.002 |
| ρ [g/cm³] | 2.29 | 2.22 | 2.26 | 2.31 |
| ∝ (20° C. to 200° C.) | 29.3 | 28.2 | 27.1 | 26.9 |
| [×10⁻⁷/° C.] | | | | |
| ∝ (20° C. to 220° C.) | 29.5 | 28.2 | 27.2 | 27.1 |
| [×10⁻⁷/° C.] | | | | |
| ∝ (20° C. to 260° C.) | 29.8 | 28.1 | 27.3 | 27.4 |
| [×10⁻⁷/° C.] | | | | |
| ∝ (20° C. to 300° C.) | 30.0 | 27.9 | 27.4 | 27.6 |
| [×10⁻⁷/° C.] | | | | |
| ∝ (30° C. to 380° C.) | 30.4 | 27.6 | 27.5 | 28.1 |
| [×10⁻⁷/° C.] | | | | |
| ∝ (20° C. to 300° C.) − ∝ (20° C. | 0.7 | −0.3 | 0.3 | 0.8 |
| to 200° C.) [×10⁻⁷/° C.] | | | | |
| Ps [° C.] | 610 | 618 | 626 | 648 |
| Ta [° C.] | 669 | 694 | 686 | 712 |
| Ts [° C.] | Unmeasured | Unmeasured | Unmeasured | 1,035 |
| 10^{4.0} dPa · s [° C.] | 1,238 | 1,415 | 1,344 | 1,282 |
| 10^{3.0} dPa · s [° C.] | 1,374 | 1,615 | 1,529 | 1,438 |
| 10^{2.5} dPa · s [° C.] | 1,477 | 1,731 | 1,642 | 1,543 |
| E [GPa] | 64 | 57 | 62 | 67 |
| TL [° C.] | Unmeasured | 1,010 or less | 1,276 | Unmeasured |
| logηTL [dPa · s] | Unmeasured | 7.7 or more | 4.51 | Unmeasured |
| β − OH [mm⁻¹] | 0.18 | Unmeasured | 0.26 | 0.19 |
| Transmittance at 265 nm | Unmeasured | Unmeasured | Unmeasured | Unmeasured |
| and thickness of 1 mm [%] | | | | |
| Transmittance at 305 nm | Unmeasured | Unmeasured | Unmeasured | Unmeasured |
| and thickness of 1 mm [%] | | | | |
| Transmittance at 355 nm | Unmeasured | Unmeasured | Unmeasured | Unmeasured |
| and thickness of 1 mm [%] | | | | |
| Transmittance at 365 nm | Unmeasured | Unmeasured | Unmeasured | Unmeasured |
| and thickness of 1 mm [%] | | | | |
| Transmittance at 1,100 nm | Unmeasured | Unmeasured | Unmeasured | Unmeasured |
| and thickness of 1 mm [%] | | | | |
| Specific dielectric | 4.59 | 4.20 | 4.39 | 4.63 |
| constant (25° C., 2.45GHz) | | | | |
| Dielectric dissipation | 0.00169 | 0.00112 | 0.0015 | 0.00185 |
| factor (25° C., 2.45 GHz) | | | | |
| Specific dielectric | Unmeasured | Unmeasured | Unmeasured | Unmeasured |
| constant (25° C., 10 GHz) | | | | |
| Dielectric dissipation | Unmeasured | Unmeasured | Unmeasured | Unmeasured |
| factor (25° C., 10 GHz) | | | | |
| Processing accuracy of | ∘ | ∘ | ∘ | ∘ |
| through holes | | | | |

TABLE 3

| | | No. 17 | No. 18 | No. 19 | No. 20 |
|---|---|---|---|---|---|
| Composition | SiO₂ | 63.69 | 59.56 | 67.38 | 61.91 |
| (mass) | Al₂O₃ | 6.6 | 12.9 | 6.6 | 12.7 |
| | B₂O₃ | 25.3 | 23.1 | 21.6 | 21.0 |
| | Na₂O | 0.02 | 0.01 | 0.01 | 0.02 |
| | K₂O | 0.002 | 0.002 | 0.003 | 0.002 |
| | MgO | 3.25 | 3.24 | 3.26 | 3.19 |
| | CaO | 0.94 | 0.93 | 0.93 | 0.91 |
| | SrO | 0.02 | 0.01 | 0.03 | 0.02 |
| | BaO | 0.00 | 0.00 | 0.00 | 0.00 |
| | ZrO₂ | 0.01 | 0.03 | 0.02 | 0.04 |
| | TiO₂ | 0.000 | 0.000 | 0.000 | 0.000 |
| | SnO₂ | 0.21 | 0.21 | 0.21 | 0.20 |
| | Fe₂O₃ | 0.004 | 0.005 | 0.004 | 0.005 |
| Mg + Ca + Sr + Ba | | 4.21 | 4.18 | 4.22 | 4.12 |
| (Mg + Ca + Sr + Ba)/Al | | 0.64 | 0.32 | 0.64 | 0.32 |
| B − (Mg + Ca + Sr + Ba) | | 21.1 | 18.9 | 17.4 | 16.9 |
| (Mg + Ca + Sr + Ba)/(Si + Al + B) | | 0.044 | 0.044 | 0.044 | 0.043 |
| B − Al | | 18.8 | 10.2 | 15.1 | 8.3 |
| Li + Na + K | | 0.022 | 0.012 | 0.013 | 0.022 |
| (Sr + Ba)/B | | 0.001 | 0.000 | 0.001 | 0.001 |
| B/(Sr + Ba) | | 1,265 | 2,310 | 720 | 1,050 |
| (Sr + Ba)/(Mg + Ca) | | 0.005 | 0.002 | 0.007 | 0.005 |
| ρ [g/cm³] | | 2.18 | 2.23 | 2.19 | 2.24 |
| ∝ (20° C. to 200° C.) [×10⁻⁷/° C.] | | 32.1 | 29.8 | 29.0 | 28.3 |
| ∝ (20° C. to 220° C.) [×10⁻⁷/° C.] | | 32.0 | 29.8 | 28.9 | 28.3 |
| ∝ (20° C. to 260° C.) [×10⁻⁷/° C.] | | 31.8 | 29.9 | 28.8 | 28.4 |
| ∝ (20° C. to 300° C.) [×10⁻⁷/° C.] | | 31.5 | 29.9 | 28.5 | 28.4 |
| ∝ (30° C. to 380° C.) [×10⁻⁷/° C.] | | 30.9 | 29.8 | 28.0 | 28.3 |
| ∝ (20° C. to 300° C.) − ∝ (20° C. to | | −0.6 | 0.1 | −0.5 | 0.1 |
| 200° C.) [×10⁻⁷/° C.] | | | | | |
| Ps [° C.] | | 560 | 577 | 572 | 589 |
| Ta [° C.] | | 618 | 646 | 648 | 664 |
| Ts [° C.] | | Unmeasured | Unmeasured | Unmeasured | Unmeasured |
| 10^{4.0} dPa · s [° C.] | | 1,309 | 1,255 | 1,373 | 1,282 |
| 10^{3.0} dPa · s [° C.] | | 1,498 | 1,424 | 1,572 | 1,456 |
| 10^{2.5} dPa · s [° C.] | | 1,616 | 1,531 | 1,695 | 1,565 |
| E [GPa] | | 51 | 57 | 54 | 59 |
| TL [° C.] | | 1,140 | 1,265 | 1,145 | 1,269 |
| logηTL [dPa · s] | | 5.3 | 3.9 | 5.8 | 4.1 |
| β − OH [mm⁻¹] | | Unmeasured | 0.26 | 0.43 | 0.29 |
| Transmittance at 265 nm and | | Unmeasured | Unmeasured | Unmeasured | Unmeasured |
| thickness of 1 mm [%] | | | | | |
| Transmittance at 305 nm and | | Unmeasured | Unmeasured | Unmeasured | Unmeasured |
| thickness of 1 mm [%] | | | | | |
| Transmittance at 355 nm and | | Unmeasured | Unmeasured | Unmeasured | Unmeasured |
| thickness of 1 mm [%] | | | | | |
| Transmittance at 365 nm and | | Unmeasured | Unmeasured | Unmeasured | Unmeasured |
| thickness of 1 mm [%] | | | | | |
| Transmittance at 1,100 nm | | Unmeasured | Unmeasured | Unmeasured | Unmeasured |
| and thickness of 1 mm [%] | | | | | |
| Specific dielectric | | 4.04 | 4.27 | 4.05 | 4.27 |
| constant (25° C., 2.45 GHz) | | | | | |
| Dielectric dissipation | | 0.00095 | 0.00133 | 0.00097 | 0.00134 |
| factor (25° C., 2.45 GHz) | | | | | |
| Specific dielectric | | Unmeasured | Unmeasured | Unmeasured | Unmeasured |
| constant (25° C., 10 GHz) | | | | | |
| Dielectric dissipation | | Unmeasured | Unmeasured | Unmeasured | Unmeasured |
| factor (25° C., 10 GHz) | | | | | |
| Processing accuracy of | | ∘ | ∘ | ∘ | ∘ |
| through holes | | | | | |
| | | No. 21 | No. 22 | No. 23 | No. 24 |
| Composition | SiO₂ | 56.63 | 71.18 | 65.65 | 60.19 |
| (mass) | Al₂O₃ | 18.6 | 6.6 | 12.7 | 18.6 |
| | B₂O₃ | 20.5 | 17.8 | 17.2 | 16.9 |
| | Na₂O | 0.01 | 0.01 | 0.01 | 0.01 |
| | K₂O | 0.002 | 0.002 | 0.003 | 0.002 |
| | MgO | 3.11 | 3.27 | 3.19 | 3.11 |
| | CaO | 0.88 | 0.93 | 0.91 | 0.87 |
| | SrO | 0.00 | 0.03 | 0.02 | 0.01 |
| | BaO | 0.00 | 0.00 | 0.00 | 0.00 |
| | ZrO₂ | 0.05 | 0.00 | 0.10 | 0.09 |
| | TiO₂ | 0.000 | 0.000 | 0.000 | 0.000 |
| | SnO₂ | 0.21 | 0.22 | 0.21 | 0.21 |
| | Fe₂O₃ | 0.004 | 0.004 | 0.005 | 0.005 |

| | | | | |
|---|---|---|---|---|
| Mg + Ca + Sr + Ba | 3.99 | 4.23 | 4.12 | 3.99 |
| (Mg + Ca + Sr + Ba)/Al | 0.21 | 0.65 | 0.32 | 0.21 |
| B − (Mg + Ca + Sr + Ba) | 16.5 | 13.6 | 13.1 | 12.9 |
| (Mg + Ca + Sr + Ba)/(Si + Al + B) | 0.042 | 0.044 | 0.043 | 0.042 |
| B-Al | 1.9 | 11.3 | 4.5 | −1.7 |
| Li + Na + K | 0.012 | 0.012 | 0.013 | 0.012 |
| (Sr + Ba)/B | 0.000 | 0.002 | 0.001 | 0.001 |
| B/(Sr + Ba) | ∞ | 593 | 860 | 1,690 |
| (Sr + Ba)/(Mg + Ca) | 0.000 | 0.007 | 0.005 | 0.003 |
| ρ [g/cm³] | 2.29 | Unmeasured | 2.25 | 2.30 |
| ∝ (20° C. to 200° C.) [×10⁻⁷/° C.] | 28.8 | 25.9 | 25.3 | 26.2 |
| ∝ (20° C. to 220° C.) [×10⁻⁷/° C.] | 28.9 | 25.9 | 25.4 | 26.3 |
| ∝ (20° C. to 260° C.) [×10⁻⁷/° C.] | 29.2 | 25.7 | 25.5 | 26.6 |
| ∝ (20° C. to 300° C.) [×10⁻⁷/° C.] | 29.3 | 25.6 | 25.5 | 26.8 |
| ∝ (30° C. to 380° C.) [×10⁻⁷/° C.] | 29.6 | 25.1 | 25.5 | 27.2 |
| ∝ (20° C. to 300° C.) − ∝ (20° C. to | 0.5 | −0.4 | 0.2 | 0.6 |
| 200° C.) [×10⁻⁷/° C.] | | | | |
| Ps [° C.] | Unmeasurable | 604 | 631 | 647 |
| Ta [° C.] | Unmeasurable | 695 | 721 | 731 |
| Ts [° C.] | Unmeasurable | Unmeasured | Unmeasured | 1,127 |
| 10^{4.0} dPa · s [° C.] | 1,238 | 1,430 | 1,334 | 1,283 |
| 10^{3.0} dPa · s [° C.] | 1,373 | 1,626 | 1,512 | 1,428 |
| 10^{2.5} dPa · s [° C.] | 1,468 | 1,737 | 1,621 | 1,527 |
| E [GPa] | 64 | Unmeasured | 62 | 68 |
| TL [° C.] | Unmeasured | 1,140 | Unmeasured | Unmeasured |
| logηTL [dPa · s] | Unmeasured | 6.6 | Unmeasured | Unmeasured |
| β − OH [mm⁻¹] | 0.15 | Unmeasured | 0.28 | 0.16 |
| Transmittance at 265 nm and | Unmeasured | Unmeasured | Unmeasured | Unmeasured |
| thickness of 1 mm [%] | | | | |
| Transmittance at 305 nm and | Unmeasured | Unmeasured | Unmeasured | Unmeasured |
| thickness of 1 mm [%] | | | | |
| Transmittance at 355 nm and | Unmeasured | Unmeasured | Unmeasured | Unmeasured |
| thickness of 1 mm [%] | | | | |
| Transmittance at 365 nm and | Unmeasured | Unmeasured | Unmeasured | Unmeasured |
| thickness of 1 mm [%] | | | | |
| Transmittance at 1,100 nm | Unmeasured | Unmeasured | Unmeasured | Unmeasured |
| and thickness of 1 mm [%] | | | | |
| Specific dielectric | 4.48 | 4.09 | 4.29 | 4.50 |
| constant (25° C., 2.45 GHz) | | | | |
| Dielectric dissipation | 0.00164 | 0.00103 | 0.00139 | 0.00175 |
| factor (25° C., 2.45 GHz) | | | | |
| Specific dielectric | Unmeasured | Unmeasured | Unmeasured | Unmeasured |
| constant (25° C., 10 GHz) | | | | |
| Dielectric dissipation | Unmeasured | Unmeasured | Unmeasured | Unmeasured |
| factor (25° C., 10 GHz) | | | | |
| Processing accuracy of | ∘ | ∘ | ∘ | ∘ |
| through holes | | | | |

TABLE 4

| | | No. 25 | No. 26 | No. 27 | No. 28 |
|---|---|---|---|---|---|
| Composition | SiO₂ | 62.39 | 56.93 | 65.93 | 60.46 |
| (mass %) | Al₂O₃ | 9.6 | 15.4 | 9.6 | 15.5 |
| | B₂O₃ | 24.7 | 24.4 | 21.1 | 20.8 |
| | Na₂O | 0.02 | 0.02 | 0.02 | 0.02 |
| | K₂O | 0.003 | 0.002 | 0.002 | 0.002 |
| | MgO | 1.28 | 1.24 | 1.28 | 1.24 |
| | CaO | 1.77 | 1.72 | 1.77 | 1.72 |
| | SrO | 0.001 | 0.008 | 0.007 | 0.009 |
| | BaO | 0.00 | 0.00 | 0.00 | 0.00 |
| | ZrO₂ | 0.04 | 0.07 | 0.08 | 0.03 |
| | TiO₂ | 0.000 | 0.000 | 0.000 | 0.002 |
| | SnO₂ | 0.19 | 0.21 | 0.21 | 0.21 |
| | Fe₂O₃ | 0.004 | 0.004 | 0.004 | 0.004 |
| Mg + Ca + Sr + Ba | | 3.05 | 2.97 | 3.06 | 2.97 |
| (Mg + Ca + Sr + Ba)/Al | | 0.32 | 0.19 | 0.32 | 0.19 |
| B − (Mg + Ca + Sr + Ba) | | 21.6 | 21.4 | 18.0 | 17.8 |
| (Mg + Ca + Sr + Ba)/(Si + Al + B) | | 0.032 | 0.031 | 0.032 | 0.031 |
| B − Al | | 15.1 | 9.0 | 11.5 | 5.3 |
| Li + Na + K | | 0.023 | 0.022 | 0.022 | 0.022 |
| (Sr + Ba)/B | | 0.000 | 0.000 | 0.000 | 0.000 |
| B/(Sr + Ba) | | 24,700 | 3,050 | 3,014 | 2,311 |
| (Sr + Ba)/(Mg + Ca) | | 0.000 | 0.003 | 0.002 | 0.003 |
| ρ [g/cm³] | | 2.19 | 2.24 | 2.20 | 2.25 |
| ∝ (20° C. to 200° C.) [×10⁻⁷/° C.] | | 30.9 | 30.8 | 27.9 | 28.0 |
| ∝ (20° C. to 220° C.) [×10⁻⁷/° C.] | | 30.8 | 30.8 | 27.9 | 28.0 |
| ∝ (20° C. to 260° C.) [×10⁻⁷/° C.] | | 30.7 | 30.9 | 27.7 | 28.1 |
| ∝ (20° C. to 300° C.) [×10⁻⁷/° C.] | | 30.5 | 30.9 | 27.5 | 28.1 |
| ∝ (30° C. to 380° C.) [×10⁻⁷/° C.] | | 30.0 | 30.8 | 27.1 | 28.1 |
| ∝ (20° C. to 300° C.) − ∝ (20° C. to | | −0.4 | 0.1 | −0.4 | 0.2 |
| 200° C.) [×10⁻⁷/° C.] | | | | | |
| Ps [° C.] | | 545 | Unmeasurable | 584 | 585 |
| Ta [° C.] | | 614 | Unmeasurable | 657 | 660 |
| Ts [° C.] | | Unmeasured | Unmeasurable | Unmeasured | Unmeasured |
| 10^{4.0} dPa · s [° C.] | | 1,292 | 1,252 | 1,352 | 1,278 |
| 10^{3.0} dPa · s [° C.] | | 1,481 | 1,390 | 1,544 | 1,444 |
| 10^{2.5} dPa · s [° C.] | | 1,597 | 1,496 | 1,659 | 1,551 |
| E [GPa] | | 51 | 57 | 55 | 60 |
| TL [° C.] | | 1,252 | Unmeasured | 1,270 | Unmeasured |
| logηTL [dPa · s] | | 4.3 | Unmeasured | 4.6 | Unmeasured |
| β − OH [mm⁻¹] | | 0.37 | 0.22 | 0.32 | 0.23 |
| Transmittance at 265 nm and | | Unmeasured | Unmeasured | Unmeasured | Unmeasured |
| thickness of 1 mm [%] | | | | | |
| Transmittance at 305 nm and | | Unmeasured | Unmeasured | Unmeasured | Unmeasured |
| thickness of 1 mm [%] | | | | | |
| Transmittance at 355 nm and | | Unmeasured | Unmeasured | Unmeasured | Unmeasured |
| thickness of 1 mm [%] | | | | | |
| Transmittance at 365 nm and | | Unmeasured | Unmeasured | Unmeasured | Unmeasured |
| thickness of 1 mm [%] | | | | | |
| Transmittance at 1,100 nm | | Unmeasured | Unmeasured | Unmeasured | Unmeasured |
| and thickness of 1 mm [%] | | | | | |
| Specific dielectric | | 4.10 | 4.30 | 4.11 | 4.31 |
| constant (25° C., 2.45 GHz) | | | | | |
| Dielectric dissipation | | 0.00087 | 0.00116 | 0.00094 | 0.00122 |
| factor (25° C., 2.45 GHz) | | | | | |
| Specific dielectric | | Unmeasured | Unmeasured | Unmeasured | Unmeasured |
| constant (25° C., 10 GHz) | | | | | |
| Dielectric dissipation | | Unmeasured | Unmeasured | Unmeasured | Unmeasured |
| factor (25° C., 10 GHz) | | | | | |
| Processing accuracy of | | ∘ | ∘ | ∘ | ∘ |
| through holes | | | | | |
| | | No. 29 | No. 30 | No. 31 | No. 32 |
| Composition | SiO₂ | 55.28 | 69.62 | 64.29 | 59.06 |
| (mass %) | Al₂O₃ | 21.1 | 9.6 | 15.6 | 21.2 |
| | B₂O₃ | 20.5 | 17.5 | 16.9 | 16.6 |
| | Na₂O | 0.02 | 0.02 | 0.02 | 0.02 |
| | K₂O | 0.002 | 0.003 | 0.002 | 0.002 |
| | MgO | 1.19 | 1.27 | 1.24 | 1.21 |
| | CaO | 1.67 | 1.76 | 1.72 | 1.68 |
| | SrO | 0.003 | 0.002 | 0.002 | 0.005 |
| | BaO | 0.00 | 0.00 | 0.00 | 0.00 |
| | ZrO₂ | 0.02 | 0.01 | 0.02 | 0.02 |
| | TiO₂ | 0.000 | 0.000 | 0.000 | 0.000 |
| | SnO₂ | 0.21 | 0.21 | 0.20 | 0.20 |
| | Fe₂O₃ | 0.005 | 0.004 | 0.005 | 0.005 |

| | | | | |
|---|---|---|---|---|
| Mg + Ca + Sr + Ba | 2.86 | 3.03 | 2.96 | 2.90 |
| (Mg + Ca + Sr + Ba)/Al | 0.14 | 0.32 | 0.19 | 0.14 |
| B − (Mg + Ca + Sr + Ba) | 17.6 | 14.5 | 13.9 | 13.7 |
| (Mg + Ca + Sr + Ba)/(Si + Al + B) | 0.030 | 0.031 | 0.031 | 0.030 |
| B − Al | −0.6 | 7.9 | 1.3 | −4.6 |
| Li + Na + K | 0.022 | 0.023 | 0.022 | 0.022 |
| (Sr + Ba)/B | 0.000 | 0.000 | 0.000 | 0.000 |
| B/(Sr + Ba) | 6,833 | 8,750 | 8,450 | 3,320 |
| (Sr + Ba)/(Mg + Ca) | 0.001 | 0.001 | 0.001 | 0.002 |
| ρ [g/cm³] | 2.30 | 2.21 | 2.27 | 2.32 |
| ∝ (20° C. to 200° C.) [×10⁻⁷/° C.] | 29.8 | 24.9 | 25.5 | 26.6 |
| ∝ (20° C. to 220° C.) [×10⁻⁷/° C.] | 29.9 | 24.9 | 25.5 | 26.8 |
| ∝ (20° C. to 260° C.) [×10⁻⁷/° C.] | 30.2 | 24.8 | 25.7 | 27.1 |
| ∝ (20° C. to 300° C.) [×10⁻⁷/° C.] | 30.3 | 24.6 | 25.7 | 27.3 |
| ∝ (30° C. to 380° C.) [×10⁻⁷/° C.] | 30.6 | 24.3 | 25.8 | 27.7 |
| ∝ (20° C. to 300° C.) − ∝ (20° C. to | 0.5 | −0.2 | 0.2 | 0.7 |
| 200° C.) [×10⁻⁷/° C.] | | | | |
| Ps [° C.] | Unmeasurable | 608 | Unmeasurable | Unmeasurable |
| Ta [° C.] | Unmeasurable | 692 | Unmeasurable | Unmeasurable |
| Ts [° C.] | Unmeasurable | Unmeasured | Unmeasurable | Unmeasurable |
| 10^{4.0} dPa · s [° C.] | Unmeasurable | 1,417 | 1,327 | Unmeasurable |
| 10^{3.0} dPa · s [° C.] | Unmeasurable | 1,615 | 1,495 | Unmeasurable |
| 10^{2.5} dPa · s [° C.] | Unmeasurable | 1,736 | 1,603 | Unmeasurable |
| E [GPa] | 66 | 58 | 64 | 69 |
| TL [° C.] | Unmeasured | Unmeasured | Unmeasured | Unmeasured |
| logηTL [dPa · s] | Unmeasured | Unmeasured | Unmeasured | Unmeasured |
| β − OH [mm⁻¹] | 0.14 | 0.39 | 0.23 | 0.15 |
| Transmittance at 265 nm and | Unmeasured | Unmeasured | Unmeasured | Unmeasured |
| thickness of 1 mm [%] | | | | |
| Transmittance at 305 nm and | Unmeasured | Unmeasured | Unmeasured | Unmeasured |
| thickness of 1 mm [%] | | | | |
| Transmittance at 355 nm and | Unmeasured | Unmeasured | Unmeasured | Unmeasured |
| thickness of 1 mm [%] | | | | |
| Transmittance at 365 nm and | Unmeasured | Unmeasured | Unmeasured | Unmeasured |
| thickness of 1 mm [%] | | | | |
| Transmittance at 1,100 nm | Unmeasured | Unmeasured | Unmeasured | Unmeasured |
| and thickness of 1 mm [%] | | | | |
| Specific dielectric | 4.52 | 4.13 | 4.34 | 4.56 |
| constant (25° C., 2.45 GHz) | | | | |
| Dielectric dissipation | 0.00147 | 0.00102 | 0.00129 | 0.00161 |
| factor (25° C., 2.45 GHz) | | | | |
| Specific dielectric | Unmeasured | Unmeasured | Unmeasured | Unmeasured |
| constant (25° C., 10 GHz) | | | | |
| Dielectric dissipation | Unmeasured | Unmeasured | Unmeasured | Unmeasured |
| factor (25° C., 10 GHz) | | | | |
| Processing accuracy of | ∘ | ∘ | ∘ | ∘ |
| through holes | | | | |

TABLE 5

| | | No. 33 | No. 34 | No. 35 | No. 36 | No. 37 | No. 38 | No. 39 | No. 40 |
|---|---|---|---|---|---|---|---|---|---|
| Composition | SiO₂ | 62.00 | 56.92 | 64.08 | 61.94 | 55.56 | 69.50 | 64.42 | 59.01 |
| (mass %) | Al₂O₃ | 9.5 | 15.4 | 11.4 | 13.7 | 21.1 | 9.6 | 15.6 | 21.2 |
| | B₂O₃ | 25.0 | 24.2 | 21.0 | 20.9 | 20.0 | 17.4 | 16.5 | 16.4 |
| | Na₂O | 0.02 | 0.02 | 0.02 | 0.02 | 0.02 | 0.02 | 0.02 | 0.02 |
| | K₂O | 0.002 | 0.002 | 0.002 | 0.002 | 0.002 | 0.002 | 0.003 | 0.002 |
| | MgO | 0.62 | 0.62 | 0.63 | 0.62 | 0.60 | 0.63 | 0.61 | 0.60 |
| | CaO | 2.63 | 2.58 | 2.61 | 2.59 | 2.51 | 2.63 | 2.59 | 2.51 |
| | SrO | 0.006 | 0.004 | 0.007 | 0.009 | 0.003 | 0.003 | 0.003 | 0.050 |
| | BaO | 0.00 | 0.00 | 0.00 | 0.00 | 0.00 | 0.00 | 0.00 | 0.00 |
| | ZrO₂ | 0.02 | 0.04 | 0.05 | 0.00 | 0.00 | 0.00 | 0.05 | 0.00 |
| | TiO₂ | 0.000 | 0.000 | 0.000 | 0.000 | 0.000 | 0.000 | 0.000 | 0.000 |
| | SnO₂ | 0.20 | 0.21 | 0.20 | 0.21 | 0.20 | 0.21 | 0.20 | 0.20 |
| | Fe₂O₃ | 0.004 | 0.004 | 0.004 | 0.004 | 0.005 | 0.004 | 0.005 | 0.005 |

| | | | | | | | | |
|---|---|---|---|---|---|---|---|---|
| Mg + Ca + Sr + Ba | 3.26 | 3.20 | 3.25 | 3.22 | 3.11 | 3.26 | 3.20 | 3.16 |
| (Mg + Ca + Sr + Ba) /Al | 0.34 | 0.21 | 0.28 | 0.23 | 0.15 | 0.34 | 0.21 | 0.15 |
| B − (Mg + Ca + Sr + Ba) | 21.7 | 21.0 | 17.8 | 17.7 | 16.9 | 14.1 | 13.3 | 13.2 |
| (Mg + Ca + Sr + Ba) / | 0.034 | 0.033 | 0.034 | 0.033 | 0.032 | 0.034 | 0.033 | 0.033 |
| (Si + Al + B) | | | | | | | | |
| B − Al | 15.5 | 8.8 | 9.6 | 7.2 | −1.1 | 7.8 | 0.9 | −4.8 |
| Li + Na + K | 0.022 | 0.022 | 0.022 | 0.022 | 0.022 | 0.022 | 0.023 | 0.022 |
| (Sr + Ba) /B | 0.000 | 0.000 | 0.000 | 0.000 | 0.000 | 0.000 | 0.000 | 0.003 |
| B/ (Sr + Ba) | 4,167 | 6,050 | 3,000 | 2,322 | 6,667 | 5,800 | 5,500 | 328 |
| (Sr + Ba) / (Mg + Ca) | 0.002 | 0.001 | 0.002 | 0.003 | 0.001 | 0.001 | 0.001 | 0.016 |
| ρ [g/cm³] | 2.19 | 2.24 | 2.22 | 2.24 | 2.31 | 2.22 | 2.27 | 2.32 |
| α (20° C. to 200° C.) | 31.2 | 30.8 | 27.9 | 28.1 | 29.0 | 25.2 | 25.4 | 26.3 |
| [×10⁻⁷/ ° C.] | | | | | | | | |
| α (20° C. to 220° C.) | 31.2 | 30.8 | 28.9 | 28.1 | 29.1 | 25.2 | 25.5 | 26.5 |
| [×10⁻⁷/ ° C.] | | | | | | | | |
| α (20° C. to 260° C.) | 31.0 | 30.9 | 27.8 | 28.2 | 29.3 | 25.2 | 25.6 | 26.8 |
| [×10⁻⁷/° C.] | | | | | | | | |
| α (20° C. to 300° C.) | 30.8 | 30.9 | 27.7 | 28.1 | 29.5 | 25.0 | 25.7 | 27.0 |
| [×10⁻⁷/° C.] | | | | | | | | |
| α (30° C. to 380° C.) | 30.3 | 30.8 | 27.5 | 28.0 | 29.8 | 24.7 | 25.7 | 27.4 |
| [×10⁻⁷/° C.] | | | | | | | | |
| α (20° C. to 300° C.) − | −0.4 | 0.1 | −0.1 | 0.0 | 0.5 | −0.2 | 0.3 | 0.7 |
| α (20° C. to 200° C.) | | | | | | | | |
| [×10⁻⁷/° C.] | | | | | | | | |
| Ps [° C.] | 547 | 560 | 575 | 584 | Unmeas- | 606 | 631 | Unmeas- |
| | | | | | urable | | | urable |
| Ta [° C.] | 614 | 625 | 645 | 655 | Unmeas- | 677 | 709 | Unmeas- |
| | | | | | urable | | | urable |
| Ts [° C.] | Unmeas- | Unmeas- | 993 | 1,004 | Unmeas- | 1,012 | Unmeas- | Unmeas- |
| | ured | ured | | | urable | | ured | urable |
| 10^{4.0} dPa · s [° C.] | 1,295 | 1,239 | 1,324 | 1,293 | Unmeas- | 1,411 | 1,327 | 1,375 |
| | | | | | urable | | | |
| 10^{3.0} dPa · s [° C.] | 1,485 | 1,389 | 1,510 | 1,471 | Unmeas- | 1,609 | 1,500 | 1,450 |
| | | | | | urable | | | |
| 10^{2.5} dPa · s [° C.] | 1,602 | 1,493 | 1,624 | 1,581 | Unmeas- | 1,731 | 1,610 | 1,524 |
| | | | | | urable | | | |
| E [GPa] | 52 | 57 | 56 | 58 | 66 | 58 | 63 | 69 |
| TL [° C.] | 1,260 | Unmeas- | 1,324 | Unmeas- | Unmea- | 1,281 | Unmeas- | Unmeas- |
| | | ured | | ured | sured | | ured | ured |
| logηTL [dPa · s] | 4.3 | Unmeas- | 4.0 | Unmeas- | Unmeas- | 4.9 | Unmeas- | Unmeas- |
| | | ured | | ured | ured | | ured | ured |
| β − OH [mm⁻¹] | Unmeas- | 0.20 | 0.35 | Unmeas- | 0.15 | 0.45 | 0.8 | 0.19 |
| | ured | | | ured | | | | |
| Transmittance at 265 nm | Unmeas- | Unmeas- | Unmeas- | Unmeas- | Unmeas- | Unmeas- | Unmeas- | Unmeas- |
| and thickness of 1 mm | ured | ured | ured | ured | ured | ured | ured | ured |
| [%] | | | | | | | | |
| Transmittance at 305 nm | Unmea- | Unmea- | Unmea- | Unmea- | Unmea- | Unmea- | Unmea- | Unmea- |
| and thickness of 1 mm | sured | sured | sured | sured | sured | sured | sured | sured |
| [%] | | | | | | | | |
| Transmittance at 355 nm | Unmea- | Unmea- | Unmea- | Unmea- | Unmea- | Unmea- | Unmea- | Unmea- |
| and thickness of 1 mm | sured | sured | sured | sured | sured | sured | sured | sured |
| [%] | | | | | | | | |
| Transmittance at 365 nm | Unmea- | Unmea- | Unmea- | Unmea- | Unmea- | Unmea- | Unmea- | Unmea- |
| and thickness of 1 mm | sured | sured | sured | sured | sured | sured | sured | sured |
| [%] | | | | | | | | |
| Transmittance at 1,100 nm | Unmea- | Unmea- | Unmea- | Unmea- | Unmea- | Unmea- | Unmea- | Unmea- |
| and thickness of 1 mm | sured | sured | sured | sured | sured | sured | sured | sured |
| [%] | | | | | | | | |
| Specific dielectric | 4.12 | 4.31 | 4.20 | 4.29 | 4.55 | 4.16 | 4.37 | 4.57 |
| constant (25° C., 2.45 GHz) | | | | | | | | |
| Dielectric dissipation | 0.00087 | 0.00113 | 0.00100 | 0.00114 | 0.00145 | 0.00099 | 0.00134 | 0.00163 |
| factor (25° C., 2.45 GHz) | | | | | | | | |
| Specific dielectric | Unmeas- | Unmeas- | Unmeas | Unmeas- | Unmeas- | Unmeas- | Unmeas- | Unmeas- |
| constant (25° C., 10 GHz) | ured | ured | -ured | ured | ured | ured | ured | ured |
| Dielectric dissipation | Unmeas- | Unmeas- | Unmeas-ured | Unmeas- | Unmeas- | Unmeas- | Unmeas- | Unmeas- |
| factor (25° C., 10 GHz) | ured | ured | | ured | ured | ured | ured | ured |
| Processing accuracy of | ∘ | ∘ | ∘ | ∘ | ∘ | ∘ | ∘ | ∘ |
| through holes | | | | | | | | |

TABLE 6

| | | No. 41 | No. 42 | No. 43 | No. 44 | No. 45 | No. 46 | No. 47 | No. 48 |
|---|---|---|---|---|---|---|---|---|---|
| Composition | SiO₂ | 62.74 | 57.28 | 66.02 | 60.71 | 54.92 | 69.73 | 64.48 | 59.03 |
| (mass %) | Al₂O₃ | 9.6 | 15.5 | 9.6 | 15.6 | 21.0 | 9.6 | 15.6 | 21.2 |
| | B₂O₃ | 24.6 | 24.2 | 21.3 | 20.7 | 21.2 | 17.6 | 16.9 | 16.8 |
| | Na₂O | 0.02 | 0.02 | 0.02 | 0.02 | 0.02 | 0.02 | 0.02 | 0.01 |
| | K₂O | 0.002 | 0.002 | 0.002 | 0.002 | 0.003 | 0.002 | 0.002 | 0.002 |
| | MgO | 1.92 | 1.86 | 1.92 | 1.86 | 1.80 | 1.92 | 1.87 | 1.82 |
| | CaO | 0.91 | 0.89 | 0.91 | 0.88 | 0.84 | 0.90 | 0.88 | 0.86 |
| | SrO | 0.003 | 0.030 | 0.003 | 0.010 | 0.003 | 0.003 | 0.006 | 0.004 |
| | BaO | 0.00 | 0.00 | 0.00 | 0.00 | 0.00 | 0.00 | 0.00 | 0.00 |
| | ZrO₂ | 0.00 | 0.00 | 0.01 | 0.01 | 0.01 | 0.01 | 0.03 | 0.06 |
| | TiO₂ | 0.000 | 0.000 | 0.000 | 0.000 | 0.000 | 0.000 | 0.000 | 0.000 |
| | SnO₂ | 0.20 | 0.21 | 0.21 | 0.21 | 0.20 | 0.21 | 0.20 | 0.21 |
| | Fe₂O₃ | 0.000 | 0.003 | 0.002 | 0.001 | 0.004 | 0.007 | 0.010 | 0.008 |

| | | | | | | | | |
|---|---|---|---|---|---|---|---|---|
| Mg + Ca + Sr + Ba | 2.83 | 2.78 | 2.83 | 2.75 | 2.64 | 2.82 | 2.76 | 2.68 |
| (Mg + Ca + Sr + Ba) /Al | 0.30 | 0.18 | 0.30 | 0.18 | 0.13 | 0.29 | 0.18 | 0.13 |
| B − (Mg + Ca + Sr + Ba) | 21.8 | 21.4 | 18.5 | 18.0 | 18.6 | 14.8 | 14.1 | 14.1 |
| (Mg + Ca + Sr + Ba) / | 0.029 | 0.029 | 0.029 | 0.028 | 0.027 | 0.029 | 0.028 | 0.028 |
| (Si + Al + B) | | | | | | | | |
| B − Al | 15.0 | 8.7 | 11.7 | 5.1 | 0.2 | 8.0 | 1.3 | −4.4 |
| Li + Na + K | 0.022 | 0.022 | 0.022 | 0.022 | 0.023 | 0.022 | 0.022 | 0.012 |
| (Sr + Ba) /B | 0.000 | 0.001 | 0.000 | 0.000 | 0.000 | 0.000 | 0.000 | 0.000 |
| B/ (Sr + Ba) | 8,200 | 807 | 7,100 | 2,070 | 7,067 | 5,867 | 2,817 | 4,200 |
| (Sr + Ba) / (Mg + Ca) | 0.001 | 0.011 | 0.001 | 0.004 | 0.001 | 0.001 | 0.002 | 0.001 |
| ρ [g/cm³] | 2.18 | 2.24 | 2.20 | 2.25 | Unmeasured | 2.21 | 2.26 | 2.32 |
| α (20° C. to 200° C.) | 30.7 | 30.6 | 27.5 | 27.8 | Unmeasured | 24.6 | 25.1 | 27.4 |
| [×10⁻⁷/° C.] | | | | | | | | |
| α (20° C. to 220° C.) | 30.6 | 30.7 | 27.4 | 27.9 | Unmeasured | 24.6 | 25.2 | 27.6 |
| [×10⁻⁷/° C.] | | | | | | | | |
| α (20° C. to 260° C.) | 30.4 | 30.7 | 27.3 | 28.0 | Unmeasured | 24.5 | 25.3 | 27.8 |
| [×10⁻⁷/° C.] | | | | | | | | |
| α (20° C. to 300° C.) | 30.2 | 30.7 | 27.1 | 27.9 | Unmeasured | 24.4 | 25.4 | 28.0 |
| [×10⁻⁷/° C.] | | | | | | | | |
| α (30° C. to 380° C.) | 29.7 | 30.5 | 26.6 | 27.9 | Unmeasured | 24.1 | 25.4 | 28.3 |
| [×10⁻⁷/° C.] | | | | | | | | |
| α (20° C. to 300° C.) − | −0.5 | 0.0 | −0.4 | 0.1 | Unmeasured | −0.2 | 0.2 | 0.6 |
| α (20° C. to 200° C.) | | | | | | | | |
| [×10⁻⁷/° C.] | | | | | | | | |
| Ps [° C.] | 540 | Unmeasurable | 568 | 586 | Unmeasured | 597 | Unmeasurable | 636 |
| Ta [° C.] | 609 | Unmeasurable | 646 | 666 | Unmeasured | 684 | Unmeasurable | 722 |
| Ts [° C.] | Unmeasured | Unmeasurable | 1,032 | Unmeasured | Unmeasured | 1,065 | Unmeasurable | Unmeasured |
| 10^{4.0} dPa · s [° C.] | 1,291 | 1,244 | 1,354 | 1,276 | Unmeasured | 1,404 | 1,323 | 1,242 |
| 10^{3.0} dPa · s [° C.] | 1,477 | 1,389 | 1,548 | 1,442 | Unmeasured | 1,596 | 1,497 | 1,411 |
| 10^{2.5} dPa · s [° C.] | 1,593 | 1,489 | 1,672 | 1,548 | Unmeasured | 1,713 | 1,606 | 1,512 |
| E [GPa] | 52 | 57 | 55 | 60 | Unmeasured | 58 | 64 | 70 |
| TL [° C.] | 1,270 | Unmeasured | 1,335 | Unmeasured | Unmeasured | 1,312 | Unmeasured | Unmeasured |
| logηTL [dPa · s] | 4.2 | Unmeasured | 4.2 | Unmeasured | Unmeasured | 4.8 | Unmeasured | Unmeasured |
| β − OH [mm⁻¹] | 0.38 | 0.20 | 0.36 | 0.24 | Unmeasured | 0.43 | 0.22 | 0.18 |
| Transmittance at 265 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Transmittance at 305 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Transmittance at 355 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Transmittance at 365 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Transmittance at 1,100 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Specific dielectric | 4.04 | 4.26 | 4.09 | 4.28 | Unmeasured | 4.10 | 4.30 | 4.50 |
| constant (25° C., 2.45 GHz) | | | | | | | | |
| Dielectric dissipation | 0.00086 | 0.00112 | 0.00091 | 0.00120 | Unmeasured | 0.00095 | 0.00124 | 0.00146 |
| factor (25° C., 2.45 GHz) | | | | | | | | |
| Specific dielectric | Unmeasured | Unmeasured | Unmeasured | Unmeasured | Unmeasured | Unmeasured | Unmeasured | Unmeasured |
| constant (25° C., 10 GHz) | | | | | | | | |
| Dielectric dissipation | Unmeasured | Unmeasured | Unmeasured | Unmeasured | Unmeasured | Unmeasured | Unmeasured | Unmeasured |
| factor (25° C., 10 GHz) | | | | | | | | |
| Processing accuracy of | ∘ | ∘ | ∘ | ∘ | ∘ | ∘ | ∘ | ∘ |
| through holes | | | | | | | | |

TABLE 7

| | | No. 49 | No. 50 | No. 51 | No. 52 | No. 53 | No. 54 | No. 55 | No. 56 |
|---|---|---|---|---|---|---|---|---|---|
| Composition | SiO₂ | 62.11 | 54.33 | 63.22 | 62.49 | 63.89 | 60.01 | 61.01 | 62.30 |
| (mass %) | Al₂O₃ | 4.8 | 4.7 | 4.8 | 3.2 | 3.2 | 7.9 | 7.9 | 7.9 |
| | B₂O₃ | 29.6 | 37.5 | 28.5 | 30.8 | 29.4 | 26.9 | 25.9 | 24.6 |
| | Na₂O | 0.02 | 0.03 | 0.01 | 0.02 | 0.02 | 0.01 | 0.00 | 0.02 |
| | K₂O | 0.007 | 0.007 | 0.005 | 0.006 | 0.007 | 0.004 | 0.004 | 0.005 |
| | MgO | 0.63 | 0.63 | 0.63 | 0.64 | 0.64 | 0.63 | 0.63 | 0.63 |
| | CaO | 2.64 | 2.61 | 2.62 | 2.65 | 2.63 | 4.32 | 4.34 | 4.33 |
| | SrO | 0.000 | 0.000 | 0.000 | 0.000 | 0.000 | 0.000 | 0.000 | 0.000 |
| | BaO | 0.00 | 0.00 | 0.00 | 0.00 | 0.00 | 0.00 | 0.00 | 0.00 |
| | ZrO₂ | 0.00 | 0.00 | 0.00 | 0.00 | 0.00 | 0.00 | 0.00 | 0.00 |
| | TiO₂ | 0.000 | 0.000 | 0.000 | 0.000 | 0.000 | 0.000 | 0.000 | 0.000 |
| | SnO₂ | 0.19 | 0.19 | 0.21 | 0.19 | 0.21 | 0.19 | 0.21 | 0.21 |
| | Fe₂O₃ | 0.003 | 0.003 | 0.003 | 0.003 | 0.004 | 0.034 | 0.004 | 0.004 |

| | | | | | | | | |
|---|---|---|---|---|---|---|---|---|
| Mg + Ca + Sr + Ba | 3.27 | 3.24 | 3.25 | 3.29 | 3.27 | 4.95 | 4.97 | 4.96 |
| (Mg + Ca + Sr + Ba) /Al | 0.68 | 0.69 | 0.68 | 1.03 | 1.02 | 0.63 | 0.63 | 0.63 |
| B − (Mg + Ca + Sr + Ba) | 26.3 | 34.3 | 25.3 | 27.5 | 26.1 | 22.0 | 20.9 | 19.6 |
| (Mg + Ca + Sr +Ba) / | 0.034 | 0.034 | 0.034 | 0.034 | 0.034 | 0.052 | 0.052 | 0.052 |
| (Si + Al + B) | | | | | | | | |
| B − Al | 24.8 | 32.8 | 23.7 | 27.6 | 26.2 | 19.0 | 18.0 | 16.7 |
| Li + Na + K | 0.027 | 0.037 | 0.015 | 0.026 | 0.027 | 0.014 | 0.004 | 0.025 |
| (Sr + Ba) /B | 0.000 | 0.000 | 0.000 | 0.000 | 0.000 | 0.000 | 0.000 | 0.000 |
| B/ (Sr + Ba) | ∞ | ∞ | ∞ | ∞ | ∞ | ∞ | ∞ | ∞ |
| (Sr + Ba) / (Mg + Ca) | 0.000 | 0.000 | 0.000 | 0.000 | 0.000 | 0.000 | 0.000 | 0.000 |
| ρ [g/cm³] | 2.14 | 2.12 | 2.15 | 2.13 | 2.13 | 2.20 | 2.20 | 2.21 |
| α (20° C. to 200° C.) | 35.1 | 41.4 | 33.4 | 36.1 | 34.7 | 33.6 | 32.8 | 32.1 |
| [×10⁻⁷/ ° C.] | | | | | | | | |
| α (20° C. to 220° C.) | 34.9 | 41.2 | 33.3 | 35.9 | 34.6 | 33.5 | 32.8 | 32.1 |
| [×10⁻⁷/° C.] | | | | | | | | |
| α (20° C. to 260° C.) | 34.6 | 40.9 | 33.0 | 35.5 | 34.2 | 33.4 | 32.7 | 32.0 |
| [×10⁻⁷/° C.] | | | | | | | | |
| α (20° C. to 300° C.) | 34.3 | 40.5 | 32.6 | 35.1 | 33.8 | 33.3 | 32.5 | 31.9 |
| [×10⁻⁷/° C.] | | | | | | | | |
| α (30° C. to 380° C.) | 33.6 | 40.0 | 31.8 | 34.2 | 33.0 | 32.9 | 32.1 | 31.5 |
| [×10⁻⁷/° C.] | | | | | | | | |
| α (20° C. to 300° C.) − | −0.8 | −0.8 | −0.8 | −1.0 | −0.9 | −0.3 | −0.3 | −0.2 |
| α (20° C. to 200° C.) | | | | | | | | |
| [×10⁻⁷/° C.] | | | | | | | | |
| Ps [° C.] | 505 | 487 | 510 | 515 | 519 | 550 | 556 | 561 |
| Ta [° C.] | 564 | 539 | 574 | 569 | 575 | 609 | 616 | 622 |
| Ts [° C.] | Unmeasured | Unmeasured | Unmeasured | Unmeasured | Unmeasured | Unmeasured | Unmeasured | Unmeasured |
| 10^{4.0} dPa · s [° C.] | 1,314 | 1,201 | 1,344 | 1,306 | 1,340 | 1,277 | 1,284 | 1,296 |
| 10^{3.0} dPa · s [° C.] | 1,519 | 1,404 | 1,552 | 1,525 | 1,556 | 1,469 | 1,477 | 1,489 |
| 10^{2.5} dPa · s [° C.] | 1,645 | 1,529 | 1,690 | 1,660 | 1,690 | 1,588 | 1,596 | 1,610 |
| E [GPa] | 46 | 42 | 47 | 45 | 46 | 52 | 53 | 53 |
| TL [° C.] | 975 | Unmeasured | 981 | 1,194 | 1,161 | 939 | 952 | 938 |
| logηTL [dPa · s] | 6.6 | Unmeasured | 6.8 | 4.7 | 5.1 | 7.1 | 7.0 | 7.3 |
| β − OH [mm⁻¹] | Unmeasured | Unmeasured | Unmeasured | Unmeasured | 1.07 | 0.70 | 0.84 | 0.79 |
| Transmittance at 265 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Transmittance at 305 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Transmittance at 355 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Transmittance at 365 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Transmittance at 1,100 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Specific dielectric | 3.94 | 3.89 | 3.96 | 3.91 | 4.06 | 4.20 | 4.21 | 4.21 |
| constant (25° C., 2.45 GHz) | | | | | | | | |
| Dielectric dissipation | 0.00066 | 0.00067 | 0.00069 | 0.00064 | 0.00066 | 0.00100 | 0.00100 | 0.00101 |
| factor (25° C., 2.45 GHz) | | | | | | | | |
| Specific dielectric | Unmeasured | Unmeasured | Unmeasured | Unmeasured | Unmeasured | Unmeasured | Unmeasured | Unmeasured |
| constant (25° C., 10 GHz) | | | | | | | | |
| Dielectric dissipation | Unmeasured | Unmeasured | Unmeasured | Unmeasured | Unmeasured | Unmeasured | Unmeasured | Unmeasured |
| factor (25° C., 10 GHz) | | | | | | | | |
| Processing accuracy of | ∘ | ∘ | ∘ | ∘ | ∘ | ∘ | ∘ | ∘ |
| through holes | | | | | | | | |

TABLE 8

| | | No. 57 | No. 58 | No. 59 | No. 60 | No. 61 | No. 62 | No. 63 | No. 64 |
|---|---|---|---|---|---|---|---|---|---|
| Comp- | SiO₂ | 61.33 | 62.12 | 62.00 | 62.22 | 62.27 | 61.34 | 62.52 | 61.83 |
| osition | Al₂O₃ | 6.3 | 3.2 | 4.8 | 6.4 | 4.8 | 7.9 | 7.9 | 8.0 |
| (mass %) | B₂O₃ | 28.9 | 31.6 | 30.1 | 28.3 | 29.6 | 27.3 | 26.1 | 27.1 |
| | Na₂O | 0.01 | 0.02 | 0.02 | 0.02 | 0.02 | 0.02 | 0.02 | 0.03 |
| | K₂O | 0.005 | 0.006 | 0.007 | 0.007 | 0.006 | 0.007 | 0.008 | 0.007 |
| | MgO | 0.63 | 1.92 | 1.93 | 1.94 | 1.29 | 0.63 | 0.64 | 1.91 |
| | CaO | 2.61 | 0.91 | 0.90 | 0.90 | 1.78 | 2.60 | 2.62 | 0.90 |
| | SrO | 0.000 | 0.000 | 0.000 | 0.000 | 0.000 | 0.000 | 0.000 | 0.000 |
| | BaO | 0.00 | 0.00 | 0.00 | 0.00 | 0.00 | 0.00 | 0.00 | 0.00 |
| | ZrO₂ | 0.00 | 0.00 | 0.00 | 0.00 | 0.00 | 0.00 | 0.00 | 0.00 |
| | TiO₂ | 0.000 | 0.003 | 0.000 | 0.004 | 0.000 | 0.000 | 0.000 | 0.005 |
| | SnO₂ | 0.21 | 0.21 | 0.21 | 0.21 | 0.21 | 0.20 | 0.19 | 0.21 |
| | Fe₂O₃ | 0.003 | 0.013 | 0.033 | 0.003 | 0.024 | 0.004 | 0.004 | 0.004 |

| | | | | | | | | |
|---|---|---|---|---|---|---|---|---|
| Mg + Ca + Sr + | 3.24 | 2.83 | 2.83 | 2.84 | 3.07 | 3.23 | 3.26 | 2.81 |
| Ba | | | | | | | | |
| (Mg + Ca + | 0.51 | 0.88 | 0.59 | 0.44 | 0.64 | 0.41 | 0.41 | 0.35 |
| Sr + Ba) /Al | | | | | | | | |
| B − (Mg + Ca + | 25.7 | 28.8 | 27.3 | 25.5 | 26.5 | 24.1 | 22.8 | 24.3 |
| Sr + Ba) | | | | | | | | |
| (Mg + Ca + Sr + | 0.034 | 0.029 | 0.029 | 0.029 | 0.032 | 0.033 | 0.034 | 0.029 |
| Ba) /(Si + Al + B) | | | | | | | | |
| B − Al | 22.6 | 28.4 | 25.3 | 21.9 | 24.8 | 19.4 | 18.2 | 19.1 |
| Li + Na + K | 0.015 | 0.026 | 0.027 | 0.027 | 0.026 | 0.027 | 0.028 | 0.037 |
| (Sr + Ba) /B | 0.000 | 0.000 | 0.000 | 0.000 | 0.000 | 0.000 | 0.000 | 0.000 |
| B/ (Sr + Ba) | ∞ | ∞ | ∞ | ∞ | ∞ | ∞ | ∞ | ∞ |
| (Sr + Ba) / | 0.000 | 0.000 | 0.000 | 0.000 | 0.000 | 0.000 | 0.000 | 0.000 |
| (Mg + Ca) | | | | | | | | |
| ρ [g/cm³] | 2.16 | 2.12 | 2.14 | 2.15 | 2.14 | 2.17 | 2.17 | 2.17 |
| α (20° C. to | 33.5 | 36.2 | 34.6 | 33.4 | 34.6 | 32.6 | 31.7 | 31.9 |
| 200° C.) | | | | | | | | |
| [×10⁻⁷/ ° C.] | | | | | | | | |
| α (20° C. to | 33.4 | 36.0 | 34.4 | 33.2 | 34.5 | 32.5 | 31.6 | 31.8 |
| 220° C.) | | | | | | | | |
| [×10⁻⁷/ ° C.] | | | | | | | | |
| α (20° C. to | 33.1 | 35.7 | 34.1 | 33.0 | 34.2 | 32.3 | 31.4 | 31.6 |
| 260° C.) | | | | | | | | |
| [×10⁻⁷/° C.] | | | | | | | | |
| α (20° C. to | 32.8 | 35.2 | 33.7 | 32.6 | 33.8 | 32.0 | 31.2 | 31.3 |
| 300° C.) | | | | | | | | |
| [×10⁻⁷/° C.] | | | | | | | | |
| α (30° C. to | 32.1 | 34.5 | 32.9 | 31.8 | 33.0 | 31.3 | 30.7 | 30.7 |
| 380° C.) | | | | | | | | |
| [×10⁻⁷/° C.] | | | | | | | | |
| α (20° C. to | −0.7 | −1.0 | −0.9 | −0.8 | −0.9 | −0.6 | −0.5 | −0.6 |
| 300° C.) − | | | | | | | | |
| α (20° C. to | | | | | | | | |
| 200° C.) | | | | | | | | |
| [×10⁻⁷/° C.] | | | | | | | | |
| Ps [° C.] | 510 | 515 | 522 | 532 | 514 | 530 | 537 | 544 |
| Ta [° C.] | 573 | 571 | 579 | 590 | 572 | 591 | 599 | 604 |
| Ts [° C.] | Un- | Un- | Un- | Un- | Un- | Un- | Un- | Un- |
| | measured | measured | measured | measured | measured | measured | measured | measured |
| 10^{4.0} dPa · s | 1,307 | 1,332 | 1,332 | 1,315 | 1,333 | 1,307 | 1,319 | 1,305 |
| [° C.] | | | | | | | | |
| 10^{3.0} dPa · s | 1,509 | 1,544 | 1,537 | 1,511 | 1,541 | 1,504 | 1,516 | 1,498 |
| [° C.] | | | | | | | | |
| 10^{2.5} dPa · s | 1,634 | 1,682 | 1,667 | 1,634 | 1,678 | 1,627 | 1,636 | 1,621 |
| [° C.] | | | | | | | | |
| E [GPa] | 48 | 44 | 46 | 47 | 46 | 49 | 50 | 49 |
| TL [° C.] | 924 | Un- | 1,119 | 1,143 | 1,028 | 1,154 | 1,157 | 1,215 |
| | | measured | | | | | | |
| logηTL | 7.2 | Un- | 5.4 | 5.2 | 6.2 | 5.1 | 5.2 | 4.6 |
| [dPa · s] | | measured | | | | | | |
| β − OH [mm⁻¹] | 0.55 | 0.95 | 0.70 | 0.60 | 0.67 | 0.41 | 0.43 | 0.44 |
| Transmittance | Un- | Un- | Un- | Un- | Un- | Un- | Un- | Un- |
| at 265 nm and | measured | measured | measured | measured | measured | measured | measured | measured |
| thickness of | | | | | | | | |
| 1 mm [%] | | | | | | | | |
| Transmittance | Un- | Un- | Un- | Un- | Un- | Un- | Un- | Un- |
| at 305 nm and | measured | measured | measured | measured | measured | measured | measured | measured |
| thickness of | | | | | | | | |
| 1 mm [%] | | | | | | | | |
| Transmittance at | Un- | Un- | Un- | Un- | Un- | Un- | Un- | Un- |
| 355 nm and | measured | measured | measured | measured | measured | measured | measured | measured |
| thickness of | | | | | | | | |
| 1 mm [%] | | | | | | | | |
| Transmittance at | Un- | Un- | Un- | Un- | Un- | Un- | Un- | Un- |
| 365 nm and | measured | measured | measured | measured | measured | measured | measured | measured |
| thickness of | | | | | | | | |
| 1 mm [%] | | | | | | | | |
| Transmittance at | Un- | Un- | Un- | Un- | Un- | Un- | Un- | Un- |
| 1,100 nm and | measured | measured | measured | measured | measured | measured | measured | measured |
| thickness of | | | | | | | | |
| 1 mm [%] | | | | | | | | |
| Specific dielectric | 4.00 | 3.85 | 3.90 | 3.96 | 3.93 | 4.06 | 4.06 | 4.00 |
| constant | | | | | | | | |
| (25° C., 2.45 GHz) | | | | | | | | |
| Dielectric | 0.00070 | 0.00066 | 0.00068 | 0.00074 | 0.00066 | 0.00082 | 0.00084 | 0.00085 |
| dissipation | | | | | | | | |
| factor | | | | | | | | |
| (25° C., 2.45 GHz) | | | | | | | | |
| Specific dielectric | 3.98 | Un- | Un- | Un- | Un- | Un- | Un- | Un- |
| constant | | measured | measured | measured | measured | measured | measured | measured |
| (25° C., 10 GHz) | | | | | | | | |
| Dielectric | 0.00120 | Un- | Un- | Un- | Un- | Un- | Un- | Un- |
| dissipation | | measured | measured | measured | measured | measured | measured | measured |
| factor | | | | | | | | |
| (25° C., 10 GHz) | | | | | | | | |
| Processing | ∘ | ∘ | ∘ | ∘ | ∘ | ∘ | ∘ | ∘ |
| accuracy | | | | | | | | |
| of through holes | | | | | | | | |

TABLE 9

| | | No. 65 | No. 66 | No. 67 | No. 68 | No. 69 | No. 70 | No. 71 | No. 72 |
|---|---|---|---|---|---|---|---|---|---|
| Composition | SiO₂ | 62.75 | 61.55 | 61.54 | 61.81 | 61.99 | 61.62 | 61.43 | 58.68 |
| (mass %) | Al₂O₃ | 8.0 | 7.5 | 7.1 | 7.5 | 7.1 | 7.1 | 7.1 | 7.0 |
| | B₂O₃ | 26.2 | 27.1 | 27.1 | 27.1 | 27.0 | 27.6 | 27.6 | 26.1 |
| | Na₂O | 0.02 | 0.00 | 0.00 | 0.00 | 0.00 | 0.00 | 0.00 | 0.00 |
| | K₂O | 0.008 | 0.000 | 0.000 | 0.000 | 0.000 | 0.000 | 0.000 | 0.000 |
| | MgO | 1.91 | 0.63 | 0.63 | 0.63 | 0.63 | 0.63 | 0.63 | 0.62 |
| | CaO | 0.90 | 2.61 | 2.61 | 2.35 | 2.18 | 2.44 | 2.62 | 2.57 |
| | SrO | 0.000 | 0.480 | 0.810 | 0.480 | 0.800 | 0.320 | 0.320 | 4.750 |
| | BaO | 0.00 | 0.00 | 0.00 | 0.00 | 0.00 | 0.00 | 0.00 | 0.01 |
| | ZrO₂ | 0.00 | 0.00 | 0.00 | 0.00 | 0.00 | 0.00 | 0.00 | 0.00 |
| | TiO₂ | 0.000 | 0.000 | 0.000 | 0.000 | 0.000 | 0.000 | 0.000 | 0.000 |
| | SnO₂ | 0.21 | 0.23 | 0.23 | 0.23 | 0.23 | 0.23 | 0.23 | 0.23 |
| | Fe₂O₃ | 0.004 | 0.004 | 0.004 | 0.004 | 0.004 | 0.004 | 0.004 | 0.034 |

| | | | | | | | | |
|---|---|---|---|---|---|---|---|---|
| Mg + Ca + Sr + Ba | 2.81 | 3.72 | 4.05 | 3.46 | 3.61 | 3.39 | 3.57 | 7.95 |
| (Mg + Ca + Sr + Ba) /Al | 0.35 | 0.50 | 0.57 | 0.46 | 0.51 | 0.47 | 0.50 | 1.13 |
| B − (Mg + Ca + Sr + Ba) | 23.4 | 23.3 | 23.0 | 23.6 | 23.4 | 24.2 | 24.1 | 18.1 |
| (Mg + Ca + Sr +Ba) / | 0.029 | 0.039 | 0.042 | 0.036 | 0.038 | 0.035 | 0.037 | 0.087 |
| (Si + Al + B) | | | | | | | | |
| B − Al | 18.2 | 19.6 | 19.9 | 19.6 | 19.9 | 20.5 | 20.5 | 19.1 |
| Li + Na + K | 0.028 | 0.000 | 0.000 | 0.000 | 0.000 | 0.000 | 0.000 | 0.000 |
| (Sr + Ba) /B | 0.000 | 0.018 | 0.030 | 0.018 | 0.030 | 0.012 | 0.012 | 0.182 |
| B/ (Sr + Ba) | ∞ | 56 | 33 | 56 | 34 | 86 | 86 | 5 |
| (Sr + Ba) / (Mg + Ca) | 0.000 | 0.148 | 0.250 | 0.161 | 0.285 | 0.104 | 0.098 | 1.492 |
| ρ [g/cm³] | 2.17 | Unmeasured | Unmeasured | Unmeasured | Unmeasured | Unmeasured | Unmeasured | Unmeasured |
| α (20° C. to 200° C.) | 31.0 | Unmeasured | Unmeasured | Unmeasured | Unmeasured | Unmeasured | Unmeasured | Unmeasured |
| [×10⁻⁷/ ° C.] | | | | | | | | |
| α (20° C. to 220° C.) | 30.9 | Unmeasured | Unmeasured | Unmeasured | Unmeasured | Unmeasured | Unmeasured | Unmeasured |
| [×10⁻⁷/ ° C.] | | | | | | | | |
| α (20° C. to 260° C.) | 30.7 | Unmeasured | Unmeasured | Unmeasured | Unmeasured | Unmeasured | Unmeasured | Unmeasured |
| [×10⁻⁷/° C.] | | | | | | | | |
| α (20° C. to 300° C.) | 30.4 | Unmeasured | Unmeasured | Unmeasured | Unmeasured | Unmeasured | Unmeasured | Unmeasured |
| [×10⁻⁷/° C.] | | | | | | | | |
| α (30° C. to 380° C.) | 29.9 | Unmeasured | Unmeasured | Unmeasured | Unmeasured | Unmeasured | Unmeasured | Unmeasured |
| [×10⁻⁷/° C.] | | | | | | | | |
| α (20° C. to 300° C.) − | −0.6 | Unmeasured | Unmeasured | Unmeasured | Unmeasured | Unmeasured | Unmeasured | Unmeasured |
| α (20° C. to 200° C.) | | | | | | | | |
| [×10⁻⁷/° C.] | | | | | | | | |
| Ps [° C.] | 547 | Unmeasured | Unmeasured | Unmeasured | Unmeasured | Unmeasured | Unmeasured | Unmeasured |
| Ta [° C.] | 609 | Unmeasured | Unmeasured | Unmeasured | Unmeasured | Unmeasured | Unmeasured | Unmeasured |
| Ts [° C.] | Unmeasured | Unmeasured | Unmeasured | Unmeasured | Unmeasured | Unmeasured | Unmeasured | Unmeasured |
| 10^{4.0} dPa · s [° C.] | 1,314 | Unmeasured | Unmeasured | Unmeasured | Unmeasured | Unmeasured | Unmeasured | Unmeasured |
| 10^{3.0} dPa · s [° C.] | 1,508 | Unmeasured | Unmeasured | Unmeasured | Unmeasured | Unmeasured | Unmeasured | Unmeasured |
| 10^{2.5} dPa · s [° C.] | 1,628 | Unmeasured | Unmeasured | Unmeasured | Unmeasured | Unmeasured | Unmeasured | Unmeasured |
| E [GPa] | 50 | Unmeasured | Unmeasured | Unmeasured | Unmeasured | Unmeasured | Unmeasured | Unmeasured |
| TL [° C.] | Unmeasured | Unmeasured | Unmeasured | Unmeasured | Unmeasured | Unmeasured | Unmeasured | Unmeasured |
| logηTL [dPa · s] | Unmeasured | Unmeasured | Unmeasured | Unmeasured | Unmeasured | Unmeasured | Unmeasured | Unmeasured |
| β − OH [mm⁻¹] | 0.43 | Unmeasured | Unmeasured | Unmeasured | Unmeasured | Unmeasured | Unmeasured | Unmeasured |
| Transmittance at 265 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Transmittance at 305 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Transmittance at 355 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Transmittance at 365 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Transmittance at 1,100 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Specific dielectric | 4.01 | Unmeasured | Unmeasured | Unmeasured | Unmeasured | Unmeasured | Unmeasured | Unmeasured |
| constant (25° C., 2.45 GHz) | | | | | | | | |
| Dielectric dissipation | 0.00081 | Unmeasured | Unmeasured | Unmeasured | Unmeasured | Unmeasured | Unmeasured | Unmeasured |
| factor (25° C., 2.45 GHz) | | | | | | | | |
| Specific dielectric | Unmeasured | Unmeasured | Unmeasured | Unmeasured | Unmeasured | Unmeasured | Unmeasured | Unmeasured |
| constant (25° C., 10 GHz) | | | | | | | | |
| Dielectric dissipation | Unmeasured | Unmeasured | Unmeasured | Unmeasured | Unmeasured | Unmeasured | Unmeasured | Unmeasured |
| factor (25° C., 10 GHz) | | | | | | | | |
| Processing accuracy of | ∘ | Unmeasured | Unmeasured | Unmeasured | Unmeasured | Unmeasured | Unmeasured | Unmeasured |
| through holes | | | | | | | | |

TABLE 10

| | | No. 73 | No. 74 | No. 75 | No. 76 | No. 77 | No. 78 | No. 79 | No. 80 |
|---|---|---|---|---|---|---|---|---|---|
| Composition | SiO₂ | 62.00 | 61.99 | 61.90 | 62.25 | 61.86 | 61.38 | 59.32 | 60.48 |
| (mass %) | Al₂O₃ | 7.5 | 7.2 | 7.5 | 7.2 | 7.2 | 7.2 | 7.3 | 7.2 |
| | B₂O₃ | 26.7 | 26.8 | 27.0 | 26.9 | 27.4 | 27.7 | 27.4 | 27.1 |
| | Na₂O | 0.01 | 0.01 | 0.02 | 0.02 | 0.01 | 0.01 | 0.00 | 0.00 |
| | K₂O | 0.003 | 0.002 | 0.002 | 0.002 | 0.003 | 0.002 | 0.003 | 0.002 |
| | MgO | 0.64 | 0.64 | 0.64 | 0.64 | 0.64 | 0.64 | 0.65 | 0.64 |
| | CaO | 2.69 | 2.71 | 2.45 | 2.28 | 2.52 | 2.70 | 2.70 | 2.71 |
| | SrO | 0.250 | 0.420 | 0.250 | 0.410 | 0.160 | 0.160 | 2.370 | 1.600 |
| | BaO | 0.00 | 0.00 | 0.00 | 0.00 | 0.00 | 0.00 | 0.02 | 0.01 |
| | ZrO₂ | 0.00 | 0.01 | 0.00 | 0.08 | 0.00 | 0.00 | 0.03 | 0.02 |
| | TiO₂ | 0.000 | 0.000 | 0.000 | 0.000 | 0.000 | 0.000 | 0.001 | 0.000 |
| | SnO₂ | 0.20 | 0.20 | 0.20 | 0.21 | 0.20 | 0.20 | 0.20 | 0.20 |
| | Fe₂O₃ | 0.004 | 0.014 | 0.033 | 0.004 | 0.004 | 0.004 | 0.004 | 0.034 |

| | | | | | | | | |
|---|---|---|---|---|---|---|---|---|
| Mg + Ca + Sr + Ba | 3.58 | 3.77 | 3.34 | 3.33 | 3.32 | 3.50 | 5.74 | 4.96 |
| (Mg + Ca + Sr + Ba) /Al | 0.48 | 0.52 | 0.45 | 0.46 | 0.46 | 0.49 | 0.79 | 0.69 |
| B − (Mg + Ca + Sr + Ba) | 23.1 | 23.0 | 23.7 | 23.6 | 24.1 | 24.2 | 21.7 | 22.1 |
| (Mg + Ca + Sr +Ba) / | 0.037 | 0.039 | 0.035 | 0.035 | 0.034 | 0.036 | 0.061 | 0.052 |
| (Si + Al + B) | | | | | | | | |
| B − Al | 19.2 | 19.6 | 19.5 | 19.7 | 20.2 | 20.5 | 20.1 | 19.9 |
| Li + Na + K | 0.013 | 0.012 | 0.022 | 0.022 | 0.013 | 0.012 | 0.003 | 0.002 |
| (Sr + Ba) /B | 0.009 | 0.016 | 0.009 | 0.015 | 0.006 | 0.006 | 0.087 | 0.059 |
| B/ (Sr + Ba) | 107 | 64 | 108 | 66 | 171 | 173 | 11 | 17 |
| (Sr + Ba) / (Mg + Ca) | 0.075 | 0.125 | 0.081 | 0.140 | 0.051 | 0.048 | 0.713 | 0.481 |
| ρ [g/cm³] | 2.17 | 2.17 | 2.17 | 2.17 | 2.16 | 2.17 | 2.21 | 2.20 |
| α (20° C. to 200° C.) | 32.4 | 32.7 | 32.2 | 32.5 | 32.9 | 33.1 | 33.6 | 33.2 |
| [×10⁻⁷/ ° C.] | | | | | | | | |
| α (20° C. to 220° C.) | 32.3 | 32.6 | 32.1 | 32.4 | 32.8 | 33.0 | 33.5 | 33.2 |
| [×10⁻⁷/ ° C.] | | | | | | | | |
| α (20° C. to 260° C.) | 32.1 | 32.4 | 31.9 | 32.2 | 32.5 | 32.7 | 33.4 | 33.0 |
| [×10⁻⁷/° C.] | | | | | | | | |
| α (20° C. to 300° C.) | 31.9 | 32.1 | 31.7 | 31.9 | 32.2 | 32.5 | 33.2 | 32.8 |
| [×10⁻⁷/° C.] | | | | | | | | |
| α (30° C. to 380° C.) | 31.3 | 31.5 | 31.0 | 31.2 | 31.6 | 31.9 | 32.8 | 32.3 |
| [×10⁻⁷/° C.] | | | | | | | | |
| α (20° C. to 300° C.) − | −0.5 | −0.6 | −0.6 | −0.7 | −0.6 | −0.6 | −0.4 | −0.5 |
| α (20° C. to 200° C.) | | | | | | | | |
| [×10⁻⁷/° C.] | | | | | | | | |
| Ps [° C.] | 532 | 529 | 525 | 522 | 522 | 523 | 544 | 543 |
| Ta [° C.] | 594 | 591 | 589 | 585 | 585 | 585 | 603 | 603 |
| Ts [° C.] | Unmeasured | Unmeasured | Unmeasured | Unmeasured | Unmeasured | Unmeasured | Unmeasured | Unmeasured |
| 10^{4.0} dPa · s [° C.] | 1,313 | 1,324 | 1,325 | 1,329 | 1,314 | 1,321 | 1,297 | 1,306 |
| 10^{3.0} dPa · s [° C.] | 1,513 | 1,525 | 1,525 | 1,530 | 1,511 | 1,521 | 1,499 | 1,503 |
| 10^{2.5} dPa · s [° C.] | 1,634 | 1,647 | 1,648 | 1,660 | 1,635 | 1,644 | 1,619 | 1,627 |
| E [GPa] | 49 | 49 | 49 | 49 | 48 | 49 | 51 | 50 |
| TL [° C.] | 1,122 | 1,060 | 1,143 | 1,169 | 1,142 | 1,119 | 911 | 924 |
| logηTL [dPa · s] | 5.4 | 6.0 | 5.3 | 5.1 | 5.2 | 5.05 | 7.4 | 7.4 |
| β − OH [mm⁻¹] | 0.50 | 0.48 | 0.53 | 0.58 | 0.50 | 0.44 | 0.44 | 0.48 |
| Transmittance at 265 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Transmittance at 305 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Transmittance at 355 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Transmittance at 365 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Transmittance at 1,100 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Specific dielectric | 4.06 | 4.06 | 4.03 | 4.06 | 4.02 | 4.04 | 4.19 | 4.11 |
| constant (25° C., 2.45 GHz) | | | | | | | | |
| Dielectric dissipation | 0.00083 | 0.00077 | 0.00074 | 0.00074 | 0.00074 | 0.00079 | 0.00093 | 0.00088 |
| factor (25° C., 2.45 GHz) | | | | | | | | |
| Specific dielectric | Unmeasured | Unmeasured | Unmeasured | Unmeasured | Unmeasured | Unmeasured | Unmeasured | Unmeasured |
| constant (25° C., 10 GHz) | | | | | | | | |
| Dielectric dissipation | | | | | | | | |
| factor (25° C., 10 GHz) | | | | | | | | |
| Processing accuracy of | ∘ | ∘ | ∘ | ∘ | ∘ | ∘ | ∘ | ∘ |
| through holes | | | | | | | | |

TABLE 11

| | | No. 81 | No. 82 | No. 83 | No. 84 | No. 85 | No. 86 | No. 87 | No. 88 |
|---|---|---|---|---|---|---|---|---|---|
| Composition | SiO₂ | 61.87 | 63.17 | 61.39 | 65.45 | 61.45 | 66.05 | 60.54 | 60.90 |
| (mass %) | Al₂O₃ | 7.0 | 8.1 | 10.3 | 12.6 | 13.3 | 9.7 | 7.2 | 7.3 |
| | B₂O₃ | 27.0 | 23.4 | 25.1 | 17.3 | 21.2 | 21.1 | 27.1 | 23.2 |
| | Na₂O | 0.04 | 0.04 | 0.05 | 0.05 | 0.08 | 0.07 | 0.00 | 0.06 |
| | K₂O | 0.008 | 0.010 | 0.008 | 0.009 | 0.006 | 0.006 | 0.000 | 0.005 |
| | MgO | 0.47 | 0.66 | 0.32 | 0.63 | 0.46 | 1.95 | 0.64 | 0.67 |
| | CaO | 3.59 | 4.43 | 2.63 | 3.96 | 3.50 | 0.90 | 2.71 | 2.66 |
| | SrO | 0.000 | 0.000 | 0.000 | 0.000 | 0.000 | 0.000 | 1.600 | 4.950 |
| | BaO | 0.00 | 0.00 | 0.00 | 0.00 | 0.00 | 0.00 | 0.01 | 0.05 |
| | ZrO₂ | 0.001 | 0.00 | 0.00 | 0.00 | 0.00 | 0.00 | 0.00 | 0.00 |
| | TiO₂ | 0.000 | 0.000 | 0.000 | 0.000 | 0.000 | 0.000 | 0.000 | 0.010 |
| | SnO₂ | 0.02 | 0.18 | 0.20 | 0.00 | 0.00 | 0.22 | 0.20 | 0.19 |
| | Fe₂O₃ | 0.004 | 0.006 | 0.004 | 0.005 | 0.006 | 0.005 | 0.004 | 0.005 |

| | | | | | | | | |
|---|---|---|---|---|---|---|---|---|
| Mg + Ca + Sr + Ba | 4.06 | 5.09 | 2.95 | 4.59 | 3.96 | 2.85 | 4.96 | 8.33 |
| (Mg + Ca + Sr + Ba) /Al | 0.58 | 0.63 | 0.29 | 0.36 | 0.30 | 0.29 | 0.69 | 1.14 |
| B − (Mg + Ca + Sr + Ba) | 22.9 | 18.3 | 22.2 | 12.7 | 17.2 | 18.3 | 22.1 | 14.9 |
| (Mg + Ca + Sr +Ba) / | 0.042 | 0.054 | 0.030 | 0.048 | 0.041 | 0.029 | 0.052 | 0.091 |
| (Si + Al + B) | | | | | | | | |
| B − Al | 20.0 | 15.3 | 14.8 | 4.7 | 7.9 | 11.4 | 19.9 | 15.9 |
| Li + Na + K | 0.048 | 0.050 | 0.058 | 0.059 | 0.086 | 0.076 | 0.000 | 0.065 |
| (Sr + Ba) /B | 0.000 | 0.000 | 0.000 | 0.000 | 0.000 | 0.000 | 0.059 | 0.216 |
| B/ (Sr + Ba) | ∞ | ∞ | ∞ | ∞ | ∞ | ∞ | 17 | 5 |
| (Sr + Ba) / (Mg + Ca) | 0.000 | 0.000 | 0.000 | 0.000 | 0.000 | 0.000 | 0.481 | 1.502 |
| ρ [g/cm³] | 2.18 | 2.22 | 2.19 | 2.25 | 2.44 | 2.20 | Unmeasured | 2.28 |
| α (20° C. to 200° C.) | 33.3 | 31.4 | 30.4 | 26.2 | 28.7 | 26.9 | Unmeasured | 34.1 |
| [×10⁻⁷/ ° C.] | | | | | | | | |
| α (20° C. to 220° C.) | 33.2 | 31.4 | 30.4 | 26.2 | 28.8 | 26.8 | Unmeasured | 34.1 |
| [×10⁻⁷/ ° C.] | | | | | | | | |
| α (20° C. to 260° C.) | 33.0 | 31.3 | 30.3 | 26.2 | 28.8 | 26.8 | Unmeasured | 34.0 |
| [×10⁻⁷/° C.] | | | | | | | | |
| α (20° C. to 300° C.) | 32.7 | 31.2 | 30.1 | 25.9 | 28.7 | 26.6 | Unmeasured | 33.9 |
| [×10⁻⁷/° C.] | | | | | | | | |
| α (30° C. to 380° C.) | 32.1 | 30.9 | 29.6 | 25.9 | 28.7 | 26.2 | Unmeasured | 33.7 |
| [×10⁻⁷/° C.] | | | | | | | | |
| α (20° C. to 300° C.) − | −0.5 | −0.2 | −0.3 | −0.3 | 0.0 | −0.3 | Unmeasured | −0.2 |
| α (20° C. to 200° C.) | | | | | | | | |
| [×10⁻⁷/° C.] | | | | | | | | |
| Ps [° C.] | 539 | 582 | 557 | 624 | 598 | 589 | Unmeasured | 583 |
| Ta [° C.] | 599 | 642 | 622 | 685 | 659 | 660 | Unmeasured | 637 |
| Ts [° C.] | 938 | 964 | 960 | 974 | 987 | 1,028 | Unmeasured | Unmeasured |
| 10^{4.0} dPa · s [° C.] | 1,334 | 1,344 | 1,316 | 1,365 | 1,296 | 1,374 | Unmeasured | 1,280 |
| 10^{3.0} dPa · s [° C.] | 1,536 | 1,539 | 1,506 | 1,549 | 1,477 | 1,569 | Unmeasured | 1,478 |
| 10^{2.5} dPa · s [° C.] | 1,659 | 1,656 | 1,624 | 1,664 | 1,588 | 1,687 | Unmeasured | 1,599 |
| E [GPa] | Unmeasured | Unmeasured | Unmeasured | Unmeasured | Unmeasured | Unmeasured | Unmeasured | Unmeasured |
| TL [° C.] | Unmeasured | Unmeasured | Unmeasured | Unmeasured | Unmeasured | Unmeasured | Unmeasured | Unmeasured |
| logηTL [dPa · s] | Unmeasured | Unmeasured | Unmeasured | Unmeasured | Unmeasured | Unmeasured | Unmeasured | Unmeasured |
| β − OH [mm⁻¹] | Unmeasured | Unmeasured | Unmeasured | Unmeasured | Unmeasured | Unmeasured | Unmeasured | Unmeasured |
| Transmittance at 265 nm | 66 | 43 | 46 | 48 | 66 | 43 | Unmeasured | 23 |
| and thickness of 1 mm | | | | | | | | |
| [%] | | | | | | | | |
| Transmittance at 305 nm | 83 | 82 | 85 | 71 | 81 | 85 | Unmeasured | 69 |
| and thickness of 1 mm | | | | | | | | |
| [%] | | | | | | | | |
| Transmittance at 355 nm | 91 | 91 | 91 | 89 | 90 | 91 | Unmeasured | 86 |
| and thickness of 1 mm | | | | | | | | |
| [%] | | | | | | | | |
| Transmittance at 365 nm | 91 | 91 | 91 | 90 | 91 | 91 | Unmeasured | 87 |
| and thickness of 1 mm | | | | | | | | |
| [%] | | | | | | | | |
| Transmittance at 1,100 nm | 93 | 93 | 93 | 93 | Unmeasured | Unmeasured | Unmeasured | Unmeasured |
| and thickness of 1 mm | | | | | | | | |
| [%] | | | | | | | | |
| Specific dielectric | 4.09 | 4.26 | 4.14 | 4.40 | 4.35 | 4.11 | Unmeasured | 4.38 |
| constant (25° C., 2.45 GHz) | | | | | | | | |
| Dielectric dissipation | 0.00090 | 0.00124 | 0.00098 | 0.00159 | 0.00145 | 0.00117 | Unmeasured | 0.00133 |
| factor (25° C., 2.45 GHz) | | | | | | | | |
| Specific dielectric | Unmeasured | Unmeasured | Unmeasured | Unmeasured | Unmeasured | Unmeasured | Unmeasured | Unmeasured |
| constant (25° C., 10 GHz) | | | | | | | | |
| Dielectric dissipation | Unmeasured | Unmeasured | Unmeasured | Unmeasured | Unmeasured | Unmeasured | Unmeasured | Unmeasured |
| factor (25° C., 10 GHz) | | | | | | | | |
| Processing accuracy of | ∘ | ∘ | ∘ | ∘ | ∘ | ∘ | Unmeasured | ∘ |
| through holes | | | | | | | | |

TABLE 12

| | | No. 89 | No. 90 | No. 91 | No. 92 | No. 93 | No. 94 | No. 95 | No. 96 |
|---|---|---|---|---|---|---|---|---|---|
| Composition | SiO₂ | 71.12 | 62.60 | 64.60 | 66.32 | 60.34 | 58.34 | 64.35 | 62.83 |
| (mass %) | Al₂O₃ | 6.5 | 10.3 | 7.1 | 7.0 | 10.2 | 13.4 | 12.8 | 12.9 |
| | B₂O₃ | 17.5 | 23.0 | 24.2 | 22.6 | 25.4 | 24.2 | 18.2 | 19.6 |
| | Na₂O | 0.02 | 0.04 | 0.02 | 0.02 | 0.03 | 0.04 | 0.04 | 0.04 |
| | K₂O | 0.002 | 0.002 | 0.002 | 0.002 | 0.002 | 0.003 | 0.003 | 0.002 |
| | MgO | 1.98 | 0.48 | 0.48 | 0.48 | 0.47 | 0.48 | 0.66 | 0.66 |
| | CaO | 2.67 | 3.57 | 3.59 | 3.57 | 3.55 | 3.53 | 3.94 | 3.96 |
| | SrO | 0.000 | 0.000 | 0.000 | 0.000 | 0.000 | 0.000 | 0.000 | 0.000 |
| | BaO | 0.00 | 0.00 | 0.00 | 0.00 | 0.00 | 0.00 | 0.00 | 0.00 |
| | ZrO₂ | 0.00 | 0.00 | 0.00 | 0.00 | 0.00 | 0.00 | 0.00 | 0.00 |
| | TiO₂ | 0.000 | 0.000 | 0.000 | 0.000 | 0.000 | 0.001 | 0.000 | 0.000 |
| | SnO₂ | 0.20 | 0.00 | 0.00 | 0.00 | 0.00 | 0.00 | 0.00 | 0.00 |
| | Fe₂O₃ | 0.005 | 0.006 | 0.005 | 0.005 | 0.005 | 0.006 | 0.006 | 0.006 |

| | | | | | | | | |
|---|---|---|---|---|---|---|---|---|
| Mg + Ca + Sr + Ba | 4.65 | 4.05 | 4.07 | 4.05 | 4.02 | 4.01 | 4.60 | 4.62 |
| (Mg + Ca + Sr + Ba) /Al | 0.72 | 0.39 | 0.57 | 0.58 | 0.39 | 0.30 | 0.36 | 0.36 |
| B − (Mg + Ca + Sr + Ba) | 12.9 | 19.0 | 20.1 | 18.6 | 21.4 | 20.2 | 13.6 | 15.0 |
| (Mg + Ca + Sr +Ba) / | 0.049 | 0.042 | 0.042 | 0.042 | 0.042 | 0.042 | 0.048 | 0.048 |
| (Si + Al + B) | | | | | | | | |
| B − Al | 11.0 | 12.7 | 17.1 | 15.6 | 15.2 | 10.8 | 5.4 | 6.7 |
| Li + Na + K | 0.022 | 0.042 | 0.022 | 0.022 | 0.032 | 0.043 | 0.043 | 0.042 |
| (Sr + Ba) /B | 0.000 | 0.000 | 0.000 | 0.000 | 0.000 | 0.000 | 0.000 | 0.000 |
| B/ (Sr + Ba) | ∞ | ∞ | ∞ | ∞ | ∞ | ∞ | ∞ | ∞ |
| (Sr + Ba) / (Mg + Ca) | 0.000 | 0.000 | 0.000 | 0.000 | 0.000 | 0.000 | 0.000 | 0.000 |
| ρ [g/cm³] | Unmeasured | Unmeasured | Unmeasured | Unmeasured | 2.20 | 2.23 | 2.25 | 2.25 |
| α (20° C. to 200° C.) | 26.9 | 30.1 | 31.4 | 30.3 | 32.0 | 30.9 | 27.2 | 28.2 |
| [×10⁻⁷/ ° C.] | | | | | | | | |
| α (20° C. to 220° C.) | 26.9 | 30.1 | 31.3 | 30.2 | 31.9 | 31.0 | 27.3 | 28.3 |
| [×10⁻⁷/ ° C.] | | | | | | | | |
| α (20° C. to 260° C.) | 26.7 | 30.0 | 31.1 | 30.0 | 31.8 | 31.0 | 27.4 | 28.4 |
| [×10⁻⁷/° C.] | | | | | | | | |
| α (20° C. to 300° C.) | 26.6 | 29.9 | 30.9 | 29.8 | 31.7 | 31.0 | 27.5 | 28.4 |
| [×10⁻⁷/° C.] | | | | | | | | |
| α (30° C. to 380° C.) | 26.2 | 29.6 | 30.3 | 29.2 | 31.3 | 30.9 | 27.6 | 28.4 |
| [×10⁻⁷/° C.] | | | | | | | | |
| α (20° C. to 300° C.) − | −0.3 | −0.2 | −0.5 | −0.5 | −0.3 | 0.1 | 0.3 | 0.2 |
| α (20° C. to 200° C.) | | | | | | | | |
| [×10⁻⁷/° C.] | | | | | | | | |
| Ps [° C.] | 616 | 582 | 561 | 573 | 567 | 585 | 623 | 616 |
| Ta [° C.] | 696 | 640 | 622 | 636 | 624 | 640 | 682 | 674 |
| Ts [° C.] | Unmeasured | Unmeasured | Unmeasured | Unmeasured | Unmeasured | 963 | Unmeasured | Unmeasured |
| 10^{4.0} dPa · s [° C.] | 1,434 | 1,316 | 1,358 | 1,385 | 1,279 | 1,252 | 1,334 | 1,309 |
| 10^{3.0} dPa · s [° C.] | 1,638 | 1,507 | 1,564 | 1,588 | 1,468 | 1,428 | 1,521 | 1,491 |
| 10^{2.5} dPa · s [° C.] | 1,774 | 1,625 | 1,678 | 1,717 | 1,583 | 1,539 | 1,634 | 1,603 |
| E [GPa] | Unmeasured | Unmeasured | Unmeasured | Unmeasured | Unmeasured | Unmeasured | Unmeasured | Unmeasured |
| TL [° C.] | Unmeasured | Unmeasured | Unmeasured | Unmeasured | Unmeasured | Unmeasured | Unmeasured | Unmeasured |
| logηTL [dPa · s] | Unmeasured | Unmeasured | Unmeasured | Unmeasured | Unmeasured | Unmeasured | Unmeasured | Unmeasured |
| β − OH [mm⁻¹] | Unmeasured | Unmeasured | Unmeasured | Unmeasured | Unmeasured | Unmeasured | Unmeasured | Unmeasured |
| Transmittance at 265 nm | Unmeasured | 26 | 55 | 51 | 30 | 24 | 25 | 25 |
| and thickness of 1 mm | | | | | | | | |
| [%] | | | | | | | | |
| Transmittance at 305 nm | Unmeasured | 55 | 77 | 76 | 58 | 52 | 54 | 54 |
| and thickness of 1 mm | | | | | | | | |
| [%] | | | | | | | | |
| Transmittance at 355 nm | Unmeasured | 86 | 91 | 90 | 87 | 86 | 87 | 86 |
| and thickness of 1 mm | | | | | | | | |
| [%] | | | | | | | | |
| Transmittance at 365 nm | Unmeasured | 88 | 91 | 91 | 89 | 88 | 89 | 88 |
| and thickness of 1 mm | | | | | | | | |
| [%] | | | | | | | | |
| Transmittance at 1,100 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Specific dielectric | 4.22 | 4.22 | 4.11 | 4.12 | 4.20 | 4.32 | 4.39 | 4.38 |
| constant (25° C., 2.45 GHz) | | | | | | | | |
| Dielectric dissipation | 0.00118 | 0.00118 | 0.00095 | 0.00095 | 0.00109 | 0.00131 | 0.00158 | 0.00150 |
| factor (25° C., 2.45 GHz) | | | | | | | | |
| Specific dielectric | Unmeasured | Unmeasured | Unmeasured | Unmeasured | Unmeasured | Unmeasured | Unmeasured | Unmeasured |
| constant (25° C., 10 GHz) | | | | | | | | |
| Dielectric dissipation | | | | | | | | |
| factor (25° C., 10 GHz) | | | | | | | | |
| Processing accuracy of | ∘ | ∘ | ∘ | ∘ | ∘ | ∘ | Unmeasured | ∘ |
| through holes | | | | | | | | |

TABLE 13

| | | No. 97 | No. 98 | No. 99 | No. 100 | No. 101 | No. 102 | No. 103 | No. 104 |
|---|---|---|---|---|---|---|---|---|---|
| Composition | SiO₂ | 64.96 | 64.52 | 63.00 | 61.89 | 62.51 | 63.18 | 61.07 | 60.70 |
| (mass %) | Al₂O₃ | 7.1 | 7.1 | 6.9 | 6.7 | 7.0 | 7.1 | 6.8 | 6.7 |
| | B₂O₃ | 26.1 | 25.9 | 25.5 | 24.9 | 25.4 | 25.4 | 24.4 | 23.2 |
| | Na₂O | 0.02 | 0.02 | 0.03 | 0.03 | 0.03 | 0.03 | 0.02 | 0.03 |
| | K₂O | 0.003 | 0.003 | 0.003 | 0.004 | 0.002 | 0.004 | 0.003 | 0.002 |
| | MgO | 1.77 | 0.02 | 0.00 | 0.00 | 2.39 | 0.05 | 0.00 | 0.71 |
| | CaO | 0.04 | 2.43 | 0.03 | 0.02 | 0.02 | 4.23 | 0.02 | 0.01 |
| | SrO | 0.000 | 0.000 | 4.470 | 0.010 | 0.020 | 0.000 | 7.610 | 0.020 |
| | BaO | 0.00 | 0.00 | 0.05 | 6.44 | 2.62 | 0.00 | 0.07 | 8.62 |
| | ZrO₂ | 0.00 | 0.00 | 0.00 | 0.00 | 0.00 | 0.00 | 0.00 | 0.00 |
| | TiO₂ | 0.000 | 0.000 | 0.009 | 0.000 | 0.000 | 0.000 | 0.000 | 0.001 |
| | SnO₂ | 0.00 | 0.00 | 0.00 | 0.00 | 0.00 | 0.00 | 0.00 | 0.00 |
| | Fe₂O₃ | 0.004 | 0.004 | 0.003 | 0.003 | 0.004 | 0.005 | 0.004 | 0.003 |

| | | | | | | | | |
|---|---|---|---|---|---|---|---|---|
| Mg + Ca + Sr + Ba | 1.81 | 2.45 | 4.55 | 6.47 | 5.05 | 4.28 | 7.70 | 9.36 |
| (Mg + Ca + Sr + Ba) /Al | 0.25 | 0.35 | 0.66 | 0.97 | 0.72 | 0.60 | 1.13 | 1.40 |
| B − (Mg + Ca + Sr + Ba) | 24.3 | 23.5 | 21.0 | 18.4 | 20.4 | 21.1 | 16.7 | 13.8 |
| (Mg + Ca + Sr +Ba) / | 0.018 | 0.025 | 0.048 | 0.069 | 0.053 | 0.045 | 0.083 | 0.103 |
| (Si + Al + B) | | | | | | | | |
| B − Al | 19.0 | 18.8 | 18.6 | 18.2 | 18.4 | 18.3 | 17.6 | 16.5 |
| Li + Na + K | 0.023 | 0.023 | 0.033 | 0.034 | 0.032 | 0.034 | 0.023 | 0.032 |
| (Sr + Ba) /B | 0.000 | 0.000 | 0.177 | 0.259 | 0.104 | 0.000 | 0.315 | 0.372 |
| B/ (Sr + Ba) | ∞ | ∞ | 6 | 4 | 10 | ∞ | 3 | 3 |
| (Sr + Ba) / (Mg + Ca) | 0.000 | 0.000 | 151 | 323 | 1.095 | 0.000 | 384 | 12 |
| ρ [g/cm³] | 2.14 | 2.15 | 2.19 | 2.22 | 2.20 | 2.18 | 2.25 | 2.27 |
| α (20° C. to 200° C.) | 30.8 | 31.5 | 32.4 | 33.4 | 31.8 | 32.6 | 34.4 | 34.4 |
| [×10⁻⁷/ ° C.] | | | | | | | | |
| α (20° C. to 220° C.) | 30.6 | 31.4 | 32.3 | 33.2 | 31.7 | 32.5 | 34.3 | 34.4 |
| [×10⁻⁷/ ° C.] | | | | | | | | |
| α (20° C. to 260° C.) | 30.3 | 31.1 | 32.0 | 32.9 | 31.4 | 32.3 | 34.1 | 34.2 |
| [×10⁻⁷/° C.] | | | | | | | | |
| α (20° C. to 300° C.) | 29.9 | 30.7 | 31.6 | 32.6 | 31.2 | 32.0 | 33.8 | 33.9 |
| [×10⁻⁷/° C.] | | | | | | | | |
| α (30° C. to 380° C.) | 29.1 | 29.9 | 30.8 | 31.8 | 30.5 | 31.5 | 33.3 | 33.3 |
| [×10⁻⁷/° C.] | | | | | | | | |
| α (20° C. to 300° C.) − | −0.9 | −0.8 | −0.8 | −0.8 | −0.6 | −0.6 | −0.6 | −0.5 |
| α (20° C. to 200° C.) | | | | | | | | |
| [×10⁻⁷/° C.] | | | | | | | | |
| Ps [° C.] | 520 | 534 | 525 | 518 | 549 | 562 | 547 | 536 |
| Ta [° C.] | 596 | 598 | 588 | 580 | 611 | 620 | 605 | 594 |
| Ts [° C.] | Unmeasured | 926 | 927 | 943 | Unmeasured | Unmeasured | 903 | 899 |
| 10^{4.0} dPa · s [° C.] | 1,348 | 1,369 | 1,373 | 1,379 | 1,333 | 1,334 | 1,330 | 1,340 |
| 10^{3.0} dPa · s [° C.] | 1,551 | 1,579 | 1,586 | 1,596 | 1,531 | 1,536 | 1,539 | 1,550 |
| 10^{2.5} dPa · s [° C.] | 1,670 | 1,706 | 1,712 | 1,728 | 1,652 | 1,654 | 1,666 | 1,670 |
| E [GPa] | Unmeasured | Unmeasured | Unmeasured | Unmeasured | Unmeasured | Unmeasured | Unmeasured | Unmeasured |
| TL [° C.] | Unmeasured | Unmeasured | Unmeasured | Unmeasured | Unmeasured | Unmeasured | Unmeasured | Unmeasured |
| logηTL [dPa · s] | Unmeasured | Unmeasured | Unmeasured | Unmeasured | Unmeasured | Unmeasured | Unmeasured | Unmeasured |
| β − OH [mm⁻¹] | Unmeasured | Unmeasured | Unmeasured | Unmeasured | Unmeasured | Unmeasured | Unmeasured | Unmeasured |
| Transmittance at 265 nm | 35 | 29 | 41 | 40 | Unmeasured | 19 | 38 | 36 |
| and thickness of 1 mm | | | | | | | | |
| [%] | | | | | | | | |
| Transmittance at 305 nm | 61 | 57 | 66 | 66 | Unmeasured | 54 | 69 | 67 |
| and thickness of 1 mm | | | | | | | | |
| [%] | | | | | | | | |
| Transmittance at 355 nm | 88 | 87 | 89 | 89 | Unmeasured | 88 | 89 | 89 |
| and thickness of 1 mm | | | | | | | | |
| [%] | | | | | | | | |
| Transmittance at 365 nm | 90 | 89 | 90 | 90 | Unmeasured | 89 | 90 | 90 |
| and thickness of 1 mm | | | | | | | | |
| [%] | | | | | | | | |
| Transmittance at 1,100 nm | Unmeasured | Unmeasured | Unmeasured | Unmeasured | Unmeasured | Unmeasured | Unmeasured | Unmeasured |
| and thickness of 1 mm | | | | | | | | |
| [%] | | | | | | | | |
| Specific dielectric | 3.90 | 3.98 | 4.02 | 4.08 | 4.06 | 4.14 | 4.21 | 4.25 |
| constant (25° C., 2.45 GHz) | | | | | | | | |
| Dielectric dissipation | 0.00070 | 0.00072 | 0.00073 | 0.00076 | 0.00093 | 0.00097 | 0.00094 | 0.00096 |
| factor (25° C., 2.45 GHz) | | | | | | | | |
| Specific dielectric | Unmeasured | Unmeasured | Unmeasured | Unmeasured | Unmeasured | Unmeasured | Unmeasured | Unmeasured |
| constant (25° C., 10 GHz) | | | | | | | | |
| Dielectric dissipation | Unmeasured | Unmeasured | Unmeasured | Unmeasured | Unmeasured | Unmeasured | Unmeasured | Unmeasured |
| factor (25° C., 10 GHz) | | | | | | | | |
| Processing accuracy of | ∘ | ∘ | ∘ | ∘ | ∘ | ∘ | ∘ | ∘ |
| through holes | | | | | | | | |

Samples No. 1 to 104 were produced in the following manner. First, glass raw materials blended so as to have a glass composition in any one of the tables were placed in a platinum crucible, and melted at 1,600° C. for 24 hours. After that, the molten glass was poured out on a carbon sheet so as to be formed into a flat sheet shape. Next, each of the resultant samples was evaluated for its density p, thermal expansion coefficient α, strain point Ps, annealing point Ta, softening point Ts, temperature at 10^{4.0} dPa·s, temperature at 10^{3.0} dPa·s, temperature at 10^{2.5} dPa·s, Young's modulus E, liquidus temperature TL, liquidus viscosity log ηTL, specific dielectric constant at 25° C. and a frequency of 2.45 GHz, dielectric dissipation factor at 25° C. and a frequency of 2.45 GHz, specific dielectric constant at 25° C. and a frequency of 10 GHz, dielectric dissipation factor at 25° C. and a frequency of 10 GHz, external transmittances in terms of a thickness of 1.0 mm, and processing accuracy of through holes. SnO₂ was used as a fining agent in this Example, but a fining agent other than SnO₂ may be used. In addition, when bubbles are satisfactorily removed by adjusting the melting conditions and the glass batch, no fining agent needs to be added.

The density ρ is a value measured by a well-known Archimedes method.

The thermal expansion coefficient α is a value measured with a dilatometer and is an average value in each of the temperature ranges of from 20° C. to 200° C., from 20° C. to 220° C., from 20° C. to 260° C., from 20° C. to 300° C., and from 30° C. to 380° C.

The strain point Ps, the annealing point Ta, and the softening point Ts are values measured based on methods of ASTM C336 and C338.

The temperature at 10^{4.0} dPa·s, the temperature at 10^{3.0} dPa·s, and the temperature at 10^{2.5} dPa·s are values measured by a platinum sphere pull up method.

The Young's modulus E is a value measured by a resonance method. As the Young's modulus increases, a specific Young's modulus (Young's modulus/density) tends to become larger, and in the case of a flat sheet shape, the deflection of glass due to its own weight becomes smaller.

The liquidus temperature TL is a value obtained by measuring a temperature at which a crystal precipitates after glass powder that passes through a standard 30-mesh sieve (500 μm) and remains on a 50-mesh sieve (300 μm) is placed in a platinum boat and kept in a gradient heating furnace for 24 hours.

The liquidus viscosity log ηTL is a value obtained by measuring the viscosity of glass at its liquidus temperature by a platinum sphere pull up method.

The specific dielectric constant and the dielectric dissipation factor at 25° C. and a frequency of 2.45 GHz, and the specific dielectric constant and the dielectric dissipation factor at 25° C. and a frequency of 10 GHz refer to values measured by a well-known cavity resonator method.

The external transmittances at wavelengths of 265 nm, 305 nm, 355 nm, 365 nm, and 1,100 nm in terms of a thickness of 1.0 mm refer to values measured with a commercially available spectrophotometer (e.g., V-670 manufactured by JASCO Corporation) using a measurement sample obtained by polishing both surfaces into optically polished surfaces (mirror surfaces).

The processing accuracy of through holes was evaluated as follows: a case in which a difference between the maximum value and the minimum value of the inner diameters of through holes formed by processing each sample under the same conditions was less than 50 μm was marked with Symbol “∘”; and a case in which the difference between the maximum value and the minimum value of the inner diameters was 50 μm or more was marked with Symbol “x”.

### Example 2

A glass batch for achieving the glass composition of Sample No. 19 shown in Table 3 was melted in a test melting furnace to provide molten glass, followed by forming thereof into a glass sheet having a thickness of 0.7 mm by an overflow down-draw method. In the forming of the glass sheet, the speed of drawing rollers, the speed of cooling rollers, the temperature distribution of a heating apparatus, the temperature of the molten glass, the flow rate of the molten glass, a sheet-drawing speed, the rotation number of a stirrer, and the like were appropriately adjusted to control the thermal shrinkage rate, total thickness variation, and warpage of the glass sheet. Next, the resultant glass sheet was cut to provide a disc-like glass sheet having an outer diameter of 12 inches (304.8 mm). The disc-like glass sheet had a warpage level of 100 μm or less and a total thickness variation of 5 μm. The “warpage level” and the “total thickness variation” are values measured with a Bow/Warp measurement apparatus SBW-331ML/d manufactured by Kobelco Research Institute, Inc. Next, the arithmetic average roughness Ra of the surface of the resultant glass sheet was measured with an atomic force microscope (AFM) and found to be 0.2 nm.

### Example 3

Glass batches for achieving the glass compositions of Sample No. 19 shown in Table 3 and Sample No. 72 shown in Table 9 were each melted in a test melting furnace to provide molten glass, followed by forming thereof into a glass sheet having a thickness of 0.3 mm by an overflow down-draw method. Next, the resultant glass sheet was cut to provide a glass sheet having a rectangular shape measuring 300 mm×400 mm. Next, a plurality of through holes were formed in the glass sheet having a rectangular shape. The through holes were produced by irradiating the surface of the glass sheet with a commercially available picosecond laser to form a modification layer, and then removing the modification layer by etching. The inner diameters of the through holes according to each of Sample No. 19 shown in Table 3 and Sample No. 91 shown in Table 12 were measured. In both cases, the maximum value was 85 μm, the minimum value was 62 μm, and the difference between the maximum value and the minimum value of the inner diameters was 23 μm. In addition, in both cases, the maximum length of a crack in a surface direction extending from the through holes was 2 μm.

Next, a high-frequency device was produced with each of the glass sheets according to Sample No. 19 shown in Table 3 and Sample No. 72 shown in Table 9. First, for the through holes of the glass sheet, a conductor circuit layer was formed by a semi-additive method. Specifically, the conductor circuit layer was formed by sequentially performing the production of a seed metal layer by a sputtering method, the formation of a metal layer by an electroless plating method, the formation of a resist pattern, and the formation of copper plating for wiring.

Subsequently, a capacitor, a coil, and the like were arranged on both surfaces of the glass sheet, an insulating resin layer was then formed, and via holes were produced. After that, desmear treatment and electroless copper plating treatment were performed, and further, a dry film resist layer was formed. A resist pattern was formed by photolithography, and then a conductor circuit layer was formed by a copper electroplating method. After that, the formation of a multilayer circuit was repeated to form build-up multilayer circuits on both surfaces of the glass sheet (glass core).

Further, for the outermost layer of the multilayer circuits, a solder resist layer was formed, an external connection terminal portion was exposed by photolithography, and plating was performed, followed by the formation of solder balls. The step of forming the solder balls had the highest heat treatment temperature among the series of steps, which was about 320° C. Finally, the glass sheet having the solder balls formed thereon was subjected to dicing processing to provide a high-frequency device.

### Example 4

Glass batches for achieving the glass compositions of Sample No. 19 shown in Table 3 and Sample No. 72 shown in Table 9 were each melted in a test melting furnace to provide molten glass, followed by forming thereof into a glass sheet having a thickness of 5.1 mm by a float method. Next, the resultant glass sheet was cut to provide a glass sheet having a rectangular shape measuring 350 mm×450 mm. The glass sheet was subjected to polishing processing until its thickness became 5.0 mm. The arithmetic average roughness Ra of the glass after the polishing processing was measured with a stylus-type surface roughness meter and found to be 500 nm. Next, a plurality of through holes were formed in the glass sheet having a rectangular shape. The through holes were produced by irradiating the surface of the glass sheet with a commercially available picosecond laser to form a modification layer, and then removing the modification layer by etching.

Next, a high-frequency device was produced with each of the glass sheets according to Sample No. 19 shown in Table 3 and Sample No. 72 shown in Table 9. First, for the through holes of the glass sheet, a conductor circuit layer was formed by a semi-additive method. Specifically, the conductor circuit layer was formed by sequentially performing the production of a seed metal layer by a sputtering method, the formation of a metal layer by an electroless plating method, the formation of a resist pattern, and the formation of copper plating for wiring.

Subsequently, a capacitor, a coil, and the like were arranged on both surfaces of the glass sheet, an insulating resin layer was then formed, and via holes were produced. After that, desmear treatment and electroless copper plating treatment were performed, and further, a dry film resist layer was formed. A resist pattern was formed by photolithography, and then a conductor circuit layer was formed by a copper electroplating method. After that, the formation of a multilayer circuit was repeated to form build-up multilayer circuits on both surfaces of the glass sheet (glass core). Peeling of the circuit layer did not occur in this process.

Further, for the outermost layer of the multilayer circuits, a solder resist layer was formed, an external connection terminal portion was exposed by photolithography, and plating was performed, followed by the formation of solder balls. The step of forming the solder balls had the highest heat treatment temperature among the series of steps, which was about 320° C. Finally, the glass sheet having the solder balls formed thereon was subjected to dicing processing to provide a high-frequency device.

### INDUSTRIAL APPLICABILITY

The glass sheet of the present invention is suitable for a high-frequency device application, and besides, is also suitable as a substrate for a printed wiring board, a substrate for a glass antenna, a substrate for a micro-LED, and a substrate for a glass interposer, each of which is required to have low dielectric characteristics. In addition, the glass sheet of the present invention is also suitable as a constituent member of a resonator of a dielectric filter, such as a duplexer.

1. A glass sheet, comprising as a glass composition, in terms of mass %, 50% to 72% of SiO₂, 0% to 22% of Al₂O₃, 15% to 38% of B₂O₃, 0% to 3% of Li₂O+Na₂O+K₂O, and 0% to 12% of MgO+CaO+SrO+BaO, and having a specific dielectric constant at 25° C. and a frequency of 10 GHz of 5 or less.

2. A glass sheet, comprising as a glass composition, in terms of mass %, 50% to 72% of SiO₂, 0% to 22% of Al₂O₃, 15% to 38% of B₂O₃, 0% to 3% of Li₂O+Na₂O+K₂O, and 0% to 12% of MgO+CaO+SrO+BaO, and having a specific dielectric constant at 25° C. and a frequency of 2.45 GHz of 5 or less.

3. A glass sheet, comprising as a glass composition, in terms of mass %, 50% to 72% of SiO₂, 0% to 22% of Al₂O₃, 15% to 38% of B₂O₃, 0% to 3% of Li₂O+Na₂O+K₂O, and 0% to 12% of MgO+CaO+SrO+BaO.

4. The glass sheet according to claim 1, wherein the glass sheet has a mass ratio (MgO+CaO+SrO+BaO)/(SiO₂+Al₂O₃+B₂O₃) of from 0.001 to 0.4.

5. The glass sheet according to claim 1, wherein the glass sheet has a plurality of through holes formed in a thickness direction.

6. The glass sheet according to claim 5, wherein the through holes have an average inner diameter of 300 μm or less.

7. The glass sheet according to claim 5, wherein a difference between a maximum value and a minimum value of inner diameters of the through holes is 50 μm or less.

8. The glass sheet according to claim 5, wherein a maximum length of a crack in a surface direction extending from the through holes is 100 μm or less.

9. The glass sheet according to claim 1, wherein the glass sheet has a dielectric dissipation factor at 25° C. and a frequency of 10 GHz of 0.01 or less.

10. The glass sheet according to claim 1, wherein the glass sheet has a Young's modulus of 40 GPa or more.

11. The glass sheet according to claim 1, wherein the glass sheet has a thermal shrinkage rate of 30 ppm or less in a case in which the glass sheet is increased in temperature at a rate of 5° C./min, kept at 500° C. for 1 hour, and decreased in temperature at a rate of 5° C./min.

12. The glass sheet according to claim 1, wherein the glass sheet has a thermal expansion coefficient in a temperature range of from 30° C. to 380° C. of from 20×10⁻⁷/° C. to 50×10⁻⁷/° C.

13. The glass sheet according to claim 1, wherein a difference between a thermal expansion coefficient in a temperature range of from 20° C. to 300° C. and a thermal expansion coefficient in a temperature range of from 20° C. to 200° C. is 1.0×10⁻⁷/° C. or less.

14. The glass sheet according to claim 1, wherein the glass sheet has an external transmittance at a wavelength of 355 nm in terms of a thickness of 1.0 mm of 80% or more.

15. The glass sheet according to claim 1, wherein the glass sheet has an external transmittance at a wavelength of 265 nm in terms of a thickness of 1.0 mm of 15% or more.

16. The glass sheet according to claim 1, wherein the glass sheet has a liquidus viscosity of 10⁴⁰ dPa·s or more.

17. The glass sheet according to claim 1, wherein the glass sheet is formed by an overflow down-draw method.

18. The glass sheet according to claim 2, wherein the glass sheet has a mass ratio (MgO+CaO+SrO+BaO)/(SiO₂+Al₂O₃+B₂O₃) of from 0.001 to 0.4.

19. The glass sheet according to claim 3, wherein the glass sheet has a mass ratio (MgO+CaO+SrO+BaO)/(SiO₂+Al₂O₃+B₂O₃) of from 0.001 to 0.4.

20. The glass sheet according to claim 2, wherein the glass sheet has a plurality of through holes formed in a thickness direction.
